(19) United States
(12) Patent Application Publication
(10) Pub. No.: US 2025/0315109 A1
(43) Pub. Date: Oct. 9, 2025

(54) METHOD AND DEVICE FOR UWB COMMUNICATION

(71) Applicant: Samsung Electronics Co., Ltd., Gyeonggi-do (KR)

(72) Inventors: Kisoo AN, Gyeonggi-do (KR); Jieun KEUM, Gyeonggi-do (KR)

(21) Appl. No.: 18/866,336

(22) PCT Filed: May 17, 2023
(86) PCT No.: PCT/KR2023/006660

§ 371 Date: Nov. 15, 2024

(30) Foreign Application Priority Data
May 18, 2022 (KR) 10-2022-0061139

(51) Int. Cl. G06F 3/01; G01S 13/76

(52) U.S. Cl. CPC G06F 3/017; G01S 13/765

(57) ABSTRACT

The present disclosure provides a service beginning using a UWB OWR, and a user gesture input method. A method of an ultra-wide band (UWB) device, according to various embodiments of the present disclosure, comprises the steps of: receiving, from a second UWB device, a first UWB advertisement message for measurement of an angle of arrival (AoA) with a third UWB device, the UWB advertisement message being a message for UWB one-way ranging (OWR) and including information about a transmission period of the UWB advertisement message; and determining, on the basis of the information about the transmission period, a mode for identifying a user gesture input of the first UWB device, wherein the mode for identifying the user gesture input can be one of a first mode using the UWB OWR in order to identify the user gesture input and a second mode using both the UWB OWR and UWB two-way ranging (TWR) with the third UWB device in order to identify the user gesture input.

### CROSS-REFERENCE TO RELATED APPLICATIONS

This application is a U.S. National Phase Entry of PCT International Application No. PCT/KR2023/006660, which was filed on May 17, 2023, and claims priority to Korean Patent Application No. 10-2022-0061139, which was filed on May 18, 2022, the entire disclosure of each of which is incorporated herein by reference.

### TECHNICAL FIELD

The disclosure relates to UWB communication and, more specifically, to a method and a device for providing service initiation and user gesture input using UWB one-way ranging (OWR).

### BACKGROUND ART

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched.

Such an IoT environment may provide intelligent Internet technology services that create a new value to human life by collecting and analyzing data generated among connected things. IoT may be applied to a variety of fields including smart homes, smart buildings, smart cities, smart cars or connected cars, smart grids, health care, smart appliances and advanced medical services through convergence and combination between existing Information Technology (IT) and various industrial applications.

As various services can be provided with the development of wireless communication systems, a method for effectively providing these services is required. For example, a ranging technique for measuring a distance between electronic devices using Ultra-Wide Band (UWB) may be used.

### DETAILED DESCRIPTION OF THE INVENTION

### Technical Problem

The disclosure provides a method and a device for providing a service initiation using a UWB OWR, and a user gesture input.

### Technical Solution

A method of an ultra-wide band (UWB) device according to one aspect of the disclosure may include steps of receiving a UWB advertisement message for measurement of an angle of arrival (AoA), wherein the UWB advertisement message is a message for UWB one-way ranging (OWR) and includes information about the transmission period of the UWB advertisement message, and determining, based on the information about a transmission period, a scheme for identifying a user gesture input of the UWB device, and the scheme for identifying the user gesture input may be one of a first scheme using the UWB OWR to identify the user gesture input and a second scheme using both the UWB OWR and UWB two-way ranging (TWR) with another UWB device to identify the user gesture input.

An ultra-wide band (UWB) device according to another aspect of the disclosure may include a transceiver and a controller, wherein the controller may be configured to receive a UWB advertisement message for measurement of an angle of arrival (AoA), wherein the UWB advertisement message is a message for UWB one-way ranging (OWR) and includes information about a transmission period of the UWB advertisement message, and determine, based on the information about the transmission period, a scheme for identifying a user gesture input of the UWB device, and the scheme for identifying the user gesture input is one of a first scheme using the UWB OWR to identify the user gesture input and a second scheme using both the UWB OWR and UWB two-way ranging (TWR) with another UWB device to identify the user gesture input.

A method of a first ultra-wide band (UWB) device according to one aspect of the disclosure may include steps of receiving, from a second UWB device, a first UWB advertisement message for measurement of an angle of arrival (AoA) with a third UWB device, wherein the UWB advertisement message is a message for UWB one-way ranging (OWR) and includes information about a transmission period of the UWB advertisement message, and determining, based on the information about the transmission period, a scheme for identifying a user gesture input of the first UWB device, and the scheme for identifying the user gesture input may be one of a first scheme using the UWB OWR to identify the user gesture input and a second scheme using both the UWB OWR and UWB two-way ranging (TWR) with the third UWB device to identify the user gesture input.

A first ultra-wide band (UWB) device according to another aspect of the disclosure may include a transceiver and a controller, wherein the controller may be configured to receive, from a second UWB device, a first UWB advertisement message for measurement of an angle of arrival (AoA) with a third UWB device, wherein the UWB advertisement message is a message for UWB one-way ranging (OWR) and includes information about a transmission period of the UWB advertisement message, and determine, based on the information about the transmission period, a scheme for identifying a user gesture input of the first UWB device, and the scheme for identifying the user gesture input is one of a first scheme using the UWB OWR to identify the user gesture input and a second scheme using both the UWB OWR and UWB two-way ranging (TWR) with the third UWB device to identify the user gesture input.

### BRIEF DESCRIPTION OF DRAWINGS

FIG. 1 illustrates an example architecture of a UWB device according to an embodiment of the disclosure.

FIG. 2 illustrates an example configuration of a framework of a UWB device according to an embodiment of the disclosure.

FIG. 3 illustrates a method for performing communication by a plurality of electronic devices according to an embodiment of the disclosure.

FIG. 4 illustrates a structure of a UWB MAC frame according to an embodiment of the disclosure.

FIG. 5 illustrates a structure of a UWB PHY packet according to an embodiment of the disclosure.

FIG. 6 illustrates an example of a structure of a ranging block and round used for UWB ranging according to an embodiment of the disclosure.

FIG. 7 illustrates a system for providing a service initiation using a UWB OWR, and a user gesture input according to an embodiment of the disclosure.

FIG. 8A illustrates a method for an electronic device to identify a user gesture input by using a first scheme according to an embodiment of the disclosure.

FIG. 8B illustrates a method for an electronic device to identify a user gesture input by using a second scheme according to an embodiment of the disclosure.

FIGS. 9A, 9B and 9C illustrate a method for an electronic device to identify a user gesture input, based on AoA information according to a first scheme according to an embodiment of the disclosure.

FIGS. 10A and 10B illustrate a method for an electronic device to identify a user gesture input, based on AoA information according to a second scheme according to an embodiment of the disclosure.

FIG. 11 illustrates an exemplary procedure of a method for an electronic device to identify a user gesture input, based on AoA information according to a second scheme according to an embodiment of the disclosure.

FIG. 12 illustrates a flowchart of a method for an electronic device to identify a user gesture input, based on AoA information according to a first scheme according to an embodiment of the disclosure.

FIG. 13 illustrates an exemplary operation situation according to the method of FIG. 12.

FIG. 14 illustrates a flowchart of a method for an electronic device to identify a user gesture input, based on AoA information according to a second scheme according to an embodiment of the disclosure.

FIG. 15 illustrates an exemplary operation situation according to the method of FIG. 14.

FIG. 16 illustrates a method for an electronic device to register a user-defined gesture according to an embodiment of the disclosure.

FIG. 17 illustrates a graph for AoA information obtained according to the method for registering the user-defined gesture of FIG. 16.

FIG. 18 illustrates a method for an electronic device to identify a user gesture input by using AoA information obtained based on an OWR message received from a plurality of UWB advertisement devices according to an embodiment of the disclosure.

FIG. 19 illustrates a graph for AoA information obtained according to a method for identifying the user gesture input of FIG. 18.

FIG. 20 illustrates a motion sensing scenario using a UWB OWR according to an embodiment of the disclosure.

FIG. 21 illustrates a graph of AoA information collected using the motion sensing scenario of FIG. 20.

FIGS. 22A and 22B illustrate diagrams comparing a graph of AoA information obtained based on a motion sensor according to an embodiment of the disclosure with a graph of AoA information obtained based on an OWR.

FIG. 23 illustrates an example of a structure of a ranging block used for a UWB OWR according to an embodiment of the disclosure.

FIG. 24 is a flowchart illustrating a method for a UWB device to identify a user gesture input by using an OWR according to an embodiment of the disclosure.

FIG. 25 is a device diagram of a UWB device according to an embodiment of the disclosure.

### MODE FOR CARRY OUT THE INVENTION

Hereinafter, embodiments of the disclosure are described in detail with reference to the accompanying drawings.

In describing embodiments, the description of technologies that are known in the art and are not directly related to the disclosure is omitted. This is for further clarifying the gist of the disclosure without making it unclear.

For the same reasons, some elements may be exaggerated or schematically shown. The size of each element does not necessarily reflect the real size of the element. The same reference numeral is used to refer to the same element throughout the drawings.

Advantages and features of the disclosure, and methods for achieving the same may be understood through the embodiments to be described below taken in conjunction with the accompanying drawings. However, the disclosure is not limited to the embodiments disclosed herein, and various changes may be made thereto. The embodiments disclosed herein are provided only to inform one of ordinary skilled in the art of the category of the disclosure. The disclosure is defined only by the appended claims. The same reference numeral denotes the same element throughout the specification.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement execution examples, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, the term “unit” is not limited as meaning a software or hardware element. A ‘unit’ may be configured in a storage medium that may be addressed or may be configured to reproduce one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. A function provided in an element or a ‘unit’ may be combined with additional elements or may be split into sub elements or sub units. Further, an element or a ‘unit’ may be implemented to reproduce one or more CPUs in a device or a security multimedia card. According to embodiments of the disclosure, a “ . . . unit” may include one or more processors.

As used herein, the term ‘terminal’ or ‘device’ may also be referred to as a mobile station (MS), user equipment (UE), user terminal (UT), terminal, wireless terminal, access terminal (AT), subscriber unit, subscriber station (SS), wireless device, wireless communication device, wireless transmit/receive unit (WTRU), mobile node, or mobile or may be referred to in other terms. Various embodiments of the terminal may include cellular phones, smart phones with wireless communication capabilities, personal digital assistants (PDAs) with wireless communication capabilities, wireless modems, portable computers with wireless communication capabilities, capturing/recording/shooting/filming devices, such as digital cameras, having wireless communication capabilities, game players with wireless communications capabilities, music storage and playback home appliances with wireless communications capabilities, Internet home appliances capable of wireless Internet access and browsing, or portable units or terminals incorporating combinations of those capabilities. Further, the terminal may include a machine to machine (M2M) terminal and a machine-type communication (MTC) terminal/device, but is not limited thereto. In the disclosure, the terminal may be referred to as an electronic device or simply as a device.

Hereinafter, the operational principle of the disclosure is described below with reference to the accompanying drawings. When determined to make the subject matter of the disclosure unclear, the detailed of the known functions or configurations may be skipped. The terms as used herein are defined considering the functions in the disclosure and may be replaced with other terms according to the intention or practice of the user or operator. Therefore, the terms should be defined based on the overall disclosure.

Hereinafter, embodiments of the disclosure are described in detail with reference to the accompanying drawings. Further, although a communication system using UWB is described in connection with embodiments of the disclosure, as an example, embodiments of the disclosure may also apply to other communication systems with similar technical background or features. For example, a communication system using Bluetooth or ZigBee may be included therein. Further, embodiments of the disclosure may be modified in such a range as not to significantly depart from the scope of the disclosure under the determination by one of ordinary skill in the art and such modifications may be applicable to other communication systems.

When determined to make the subject matter of the disclosure unclear, the detailed description of the known art or functions may be skipped. The terms as used herein are defined considering the functions in the disclosure and may be replaced with other terms according to the intention or practice of the user or operator. Therefore, the terms should be defined based on the overall disclosure.

In general, wireless sensor network technology is largely divided into a wireless local area network (WLAN) technology and a wireless personal area network (WPAN) technology according to the recognition distance. In this case, WLAN is a technology based on IEEE 802.11 which enables access to the backbone network within a radius of about 100 m. WPAN is a technology based on IEEE 802.15 which includes Bluetooth, ZigBee, and ultra-wide band (UWB). A wireless network in which such a wireless network technology is implemented may include a plurality of electronic devices.

According to the definitions by the Federal Communications Commission (FCC), UWB may refer to a wireless communication technology that uses a bandwidth of 500 MHz or more or a bandwidth corresponding to a center frequency of 20% or more. UWB may mean a band itself to which UWB communication is applied. UWB may enable secure and accurate ranging between devices. Thus, UWB enables relative position estimation based on the distance between two devices or accurate position estimation of a device based on the distance from fixed devices (whose positions are known).

The terminology used herein is provided for a better understanding of the disclosure, and changes may be made thereto without departing from the technical spirit of the disclosure.

“Application dedicated file (ADF)” may be, for example, a data structure in an application data structure that may host an application or application specific data.

“Application protocol data unit (APDU)” may be a command and a response used when communicating with the application data structure in the UWB device.

“Application specific data” may be, e.g., a file structure having a root level and an application level including UWB controllee information and UWB session data required for a UWB session.

“Controller” may be a ranging device that defines and controls ranging control messages (RCM) (or control messages).

“Controllee” may be a ranging device using a ranging parameter in the RCM (or control message) received from the controller.

Unlike “static STS,” “dynamic scrambled timestamp sequence (STS) mode” may be an operation mode in which the STS is not repeated during a ranging session. In this mode, the STS may be managed by the ranging device, and the ranging session key that generates STS may be managed by a secure component.

“Applet” may be, e.g., an applet executed on the secure component including UWB parameters and service data. In this disclosure, Applet may be a FiRa Applet defined by FiRa.

“Ranging device” may be a device capable of performing UWB ranging. In the disclosure, the Ranging Device may be an Enhanced Ranging Device (ERDEV) defined in IEEE 802.15.4z or a FiRa Device defined by FiRa. The Ranging Device may be referred to as a UWB device.

“UWB-enabled Application” may be an application for UWB service. For example, the UWB-enabled Application may be an application using a Framework API for configuring an OOB Connector, a Secure Service, and/or a UWB service for a UWB session. In this disclosure, “UWB-enabled Application” may be abbreviated as an application or a UWB application. UWB-enabled Application may be a FiRa-enabled Application defined by FiRa.

“Framework” may be a component that provides access to Profiles, individual-UWB configuration and/or notifications. “Framework” may be, e.g., a collection of logical software components including Profile Manager, OOB Connector, Secure Service, and/or UWB service. In the disclosure, the Framework may be a FiRa Framework defined by FiRa.

“OOB Connector” may be a software component for establishing an out-of-band (OOB) connection (e.g., BLE connection) between Ranging Devices. In the disclosure, the OOB Connector may be a FiRa OOB Connector defined by FiRa.

“Profile” may be a previously defined set of UWB and OOB configuration parameters. In the disclosure, Profile may be a FiRa Profile defined by FiRa.

“Profile Manager” may be a software component that implements a profile available on the Ranging Device. In the disclosure, the Profile Manager may be a FiRa Profile Manager defined by FiRa.

“Service” may be an implementation of a use case that provides a service to an end-user.

“Smart Ranging Device” may be a ranging device that may implement an optional Framework API. In the disclosure, the Smart Ranging Device may be a FiRa Smart Device defined by FiRa.

“Global Dedicated File (GDF)” may be a root level of application specific data including data required to establish a USB session.

“Framework API” may be an API used by a UWB-enabled Application to communicate with the Framework.

“Initiator” may be a Ranging Device that initiates a ranging exchange.

“Object Identifier (OID)” may be an identifier of the ADF in the application data structure.

“Out-Of-Band (OOB)” may be data communication that does not use UWB as an underlying wireless technology.

“Ranging Data Set (RDS)” may be data (e.g., UWB session key, session ID, etc.) required to establish a UWB session when it is needed to protect confidentiality, authenticity and integrity.

“Responder” may be a ranging device that responds to the Initiator in a ranging exchange.

“STS” may be a ciphered sequence for increasing the integrity and accuracy of ranging measurement timestamps. The STS may be generated from the ranging session key.

“Secure channel” may be a data channel that prevents overhearing and tampering.

“Secure Component” may be an entity (e.g., SE or TEE) having a defined security level that interfaces with UWBS for the purpose of providing RDS to UWBS, e.g., when dynamic STS is used.

“Secure element (SE)” may be a tamper-resistant secure hardware component that may be used as a Secure Component in the Ranging Device.

“Secure ranging” may be ranging based on STS generated through a strong encryption operation.

“Secure Service” may be a software component for interfacing with a Secure Component, such as a Secure Element or Trusted Execution Environment (TEE).

“Service Applet” may be an applet on a Secure Component that handles service specific transactions.

“Service data” may be data defined by a service provider that needs to be transferred between two ranging devices to implement a service.

“Service provider” may be an entity that defines and provides hardware and software required to provide a specific service to an end-user.

“Static STS mode” is an operation mode in which STS is repeated during a session, and does not need to be managed by the Secure Component.

“Secure UWB Service (SUS) Applet” may be an applet on the SE that communicates with the applet to retrieve data needed to enable secure UWB sessions with other ranging devices. The SUS Applet may transfer corresponding data (information) to the UWBS.

“UWB Service” may be a software component that provides access to the UWBS.

“UWB Session” may be a period from when the Controller and the Controllee start communication through UWB until the communication stops. A UWB Session may include ranging, data transfer, or both ranging and data transfer.

“UWB Session ID” may be an ID (e.g., a 32-bit integer) that identifies the UWB Session, shared between the controller and the controller.

“UWB session key” may be a key used to protect the UWB Session. The UWB Session Key may be used to generate the STS. In this disclosure, the UWB session key may be a UWB ranging session key (URSK), and may be abbreviated as a session key.

“UWB subsystem (UWBS)” may be a hardware component implementing the UWB PHY and MAC layers specifications. UWBS may have an interface to Framework and an interface to Secure Component to search for RDS.

“Scheduled-based ranging” may be used for a ranging round in which controllers are scheduled by a controller to transmit RFRAME and/or measurement reports in different ranging slots. In the disclosure, scheduled-based ranging may also be referred to as time-scheduled ranging. The scheduling mode in which the scheduled-based ranging is used may be referred to as time-scheduled mode.

“Contention-based ranging” may be used when a controller does not know the MAC addresses of the controllers participating in a UWB session (ranging session). In the contention-based ranging, the controller may be an initiator and may perform ranging with another unknown UWB devices. In the disclosure, a scheduling mode in which the contention-based ranging is used may be referred to as contention-based mode.

The contention-based ranging may be used for a ranging round in which the controller determines the size of a contention access period (CAP) and informs the CAP size through a ranging control message. In the disclosure, the contention access period may be referred to as a contention window or contention window period.

In the content-based mode, a UWB device may operate as a controller and an initiator, and in this case, the ranging control phase (RCP) and the ranging initiation phase (RIP) may be merged into a RIP. In the ranging phase (RP), the allocation of CAP size may determine a CAP period for a responder (responders) participating in the ranging round in units of ranging slots. Each responder may randomly select one slot within the CAP to transmit the ranging response message (RRM). Messages used in the contention-based ranging may use SP1 as the RFRAME configuration.

“Hybrid ranging” may be used when there is a known controlee and unknown controllee. As described above, the known controllee may be a controllee whose MAC address the controller knows, and the unknown controllee may be a controllee whose MAC address the controller does not know. In the disclosure, the hybrid ranging may be referred to as hybrid-based ranging. The scheduling mode in which the hybrid ranging is used may be referred to as Hybrid-based Mode.

In the Hybrid-based Mode, the controller may perform ranging in a scheduling-based mode with a known controllee and in a contention-based mode with a unknown controllee.

In the Hybrid-based Mode, the ranging round may include a ranging control phase (RCP) and a ranging phase (RP). The RP may include a contention free period for scheduling-based ranging (access) and a contention access period (CAP) for contention-based ranging (access). In the disclosure, a control message (ranging control message) used in the RCP of Hybrid-based Mode may be referred to as a ranging management message (RMM).

“UWB message” may be a message including a payload IE transmitted by the UWB device (e.g., ERDEV). For example, the UWB message may be a message, such as a ranging initiation message (RIM), a ranging response message (RRM), a ranging final message (RFM), a control message (CM), a measurement report message (MRM), a ranging result report message (RRRM), a control update message (CUM), a one-way ranging (OWR) message. If necessary, a plurality of messages may be merged into one message.

“Payload IE” may be referred to as a payload information element and may be included in the MAC payload of the UWB MAC frame defined in IEEE 802.15.4/4z. The MAC payload may include a plurality of payload IEs.

“Data Message IE (Data Message Payload IE)” may be an additional payload IE for transmitting application data. Application data may be data transferred from a framework or application above the UWB MAC Layer.

The data message IE may be used in the procedure of two-way ranging (TWR). In this case, the ranging message (UIB message) may include at least one or both of the payload IE for ranging and the data message IE for application data transfer. For example, the data message IE may be included and transmitted as part of the payload IE of the MAC payload of a ranging initiation message (RIM) for ranging, a ranging response message (RRM), a ranging final message (RFM), a measurement report message (MRM) and ranging result report message (RRRM).

The data message IE may be used in the procedure of one-way ranging (OWR) for angle of arrival (AoA) measurement. In this case, the AoA measurement message may include at least one or both of the payload IE for AoA measurement and the data message IE for application data transfer. For example, the data message IE may be included and transmitted as part of the payload IE of the MAC payload of the AoA measurement message.

“OWR” may be a ranging scheme using messages transmitted in one direction between a ranging device and one or more other ranging devices. The OWR may be used to measure Time Difference of Arrival (TDoA). Additionally, the OWR may be used to measure AoA at the receiving end, rather than measuring TDoA. In this case, a pair of one advertiser and one observer may be used. The OWR for measuring AoA causes the observer to receive an OWR message from the advertiser and measures AoA to determine the user's intent, action, or motion of the observer. For example, a user's intention to control a particular advertiser may be verified by the results of AoA measurements for OWR messages from the advertiser. In the disclosure, OWR may be referred to as UWB OWR.

“Advertiser” is a ranging device that transmits an AoA measurement message. The advertiser may include application data (application payload data) as part of the MAC payload of the AoA measurement message by using a data message IE. The application data may be configured by an upper layer. In the disclosure, the advertiser may be referred to as an advertiser device, a UWB advertiser device. In the disclosure, the AoA measurement message may also be referred to as an OWB message for AoA measurement, a UWB OWR message for AoA measurement, a UWB advertisement message, an advertisement message, etc.

“Observer” is a ranging device that receives AoA measurement messages and measures AoA for each message. The observer may transmit the measured AoA to a upper layer. When the application data is included in the MAC payload of the AoA measurement message, the observer may transmit the application data to the upper layer. In the disclosure, the observer may be referred to as an observer device and a UWB observer device.

“TWR” may be a ranging scheme capable of estimating a relative distance between two devices by measuring time of flight (ToF) through the exchange of ranging messages between the two devices. The TWR scheme may be one of double-sided two-way ranging (DS-TWR) and single-sided two-way ranging (SS-TWR). SS-TWR may be a procedure for performing ranging through one round-trip time measurement. DS-TWR may be a procedure for performing ranging through two round-trip time measurements. For example, DS-TWR may include a transmission operation of RIM from an initiator to a responder, a transmission operation of RRM from the responder to the initiator, and a transmission operation of RRM from the initiator to the responder. In the TWR process, measured AoA information (e.g., AoA azimuth result and AoA elevation result) may be transmitted to another ranging device through RRRM or another message. In the disclosure, TWR may be referred to as UWB TWR.

“AoA” is the angle of arrival of a received signal, which may be expressed as a relative angle such as AoA azimuth and AoA elevation. Meanwhile, it may be assumed that the measuring device is a mobile phone with a display, the Y axis is the vertical display axis of the phone, the X axis is the horizontal display axis of the phone, and the Z axis is orthogonal to the phone display. In this case, the AoA azimuth angle may be a relative angle between the input signal projected on the XZ plane and the Z axis, and the AoA elevation angle may be a relative angle between the input signal and the XZ plane.

In the case of TWR, the controller (initiator) may measure AoA azimuth for an RRM and transmit the measured AoA azimuth through the UCI notification message. The controllee (responder) may measure the AoA azimuth for an RIM message and transmit the measured AoA azimuth through the RRRM.

In the case of TWR, the controller (initiator) may measure AoA elevation for an RRM and transmit the measured AoA elevation through the UCI notification message. The controllee (responder) may measure the AoA elevation for an RIM message and transmit the measured AoA elevation through the RRRM.

In the case of OWR, the observer may measure AoA azimuth and AoA elevation for an AoA measurement message.

When determined to make the subject matter of the disclosure unclear, the detailed description of the known art or functions may be skipped.

Hereinafter, various embodiments of the disclosure are described with reference to the accompanying drawings.

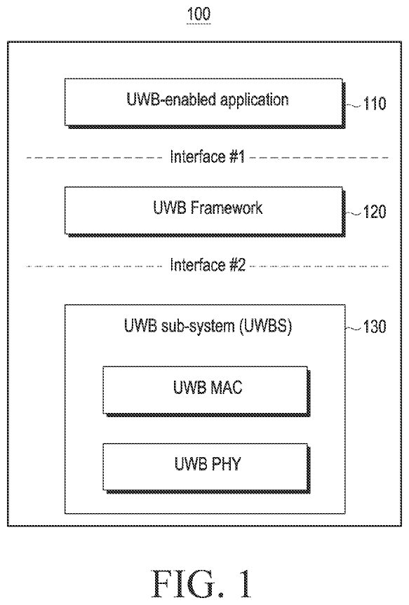

FIG. 1 illustrates an example architecture of a UWB device according to an embodiment of the disclosure;

In the disclosure, the UWB device 100 may be an electronic device supporting UWB communication. The UWB device 100 may be, e.g., a ranging device supporting UWB ranging. In an embodiment, the Ranging Device may be an ERDEV or a FiRa Device.

In the embodiment of FIG. 1, the UWB device 100 may interact with other UWB devices through a UWB session.

The UWB device 100 may implement a first interface (Interface #1) that is an interface between the UWB-enabled Application 110 and the Framework 120, and the first interface allows the UWB-enabled application 110 on the UWB device 100 to use the UWB capabilities of the UWB device 100 in a predetermined manner. In an embodiment, the first interface may be a Framework API or a proprietary interface, but is not limited thereto.

The UWB device 100 may implement a second interface (Interface #2) that is an interface between the UWB Framework 110 and the UWB subsystem (UWBS, 130). In an embodiment, the second interface may be a UWB Command Interface (UCI) or proprietary interface, but is not limited thereto.

Referring to FIG. 1, the UWB device 100 may include a UWB-enabled Application 110, a Framework (UWB Framework) 120, and/or a UWBS 130 including a UWB MAC Layer and a UWB Physical Layer. Depending on the embodiment, some entities may not be included in the UWB device, or additional entities (e.g., security layer) may be further included.

The UWB-enabled Application 110 may trigger establishment of a UWB session by a UWBS 130 through the first interface. The UWB-enabled Application 110 may use one of previously defined profiles (profile). For example, the UWB-enabled Application 110 may use one of the profiles defined in FiRa or a custom profile. The UWB-enabled Application 110 may use the first interface to handle related events, such as service discovery, ranging notifications, and/or error conditions.

The Framework 120 may provide access to Profiles, individual-UWB configuration and/or notifications. The Framework 120 may support at least one of a function for UWB ranging and transaction execution, a function to provide an interface to the application and UWBS 130, or a function to estimate the location of the device 100. The Framework 120 may be a set of software components. As described above, the UWB-enabled Application 110 may interface with the Framework 120 through the first interface, and the Framework 120 may interface with the UWBS 130 through the second interface.

Meanwhile, in the disclosure, the UWB-enabled Application 110 and/or Framework 120 may be implemented by an application processor (AP) (or processor). Accordingly, in the disclosure, the operation of the UWB-enabled Application 110 and/or the Framework 120 may be understood as performed by an AP (or a processor). In this disclosure, the framework may be referred to as an AP or a processor.

The UWBS 130 may be a hardware component including a UWB MAC Layer and a UWB Physical Layer. The UWBS 130 may perform UWB session management and may communicate with the UWBS of another UWB device. The UWBS 130 may interface with the Framework 120 through the second interface and may obtain the security data from the Secure Component. In an embodiment, the Framework (or application processor) 120 may transmit a command to the UWBS 130 through UCI, and the UWBS 130 may transmit a response to the command to the Framework 120. The UWBS 130 may transfer a notification to the Framework 120 through the UCI.

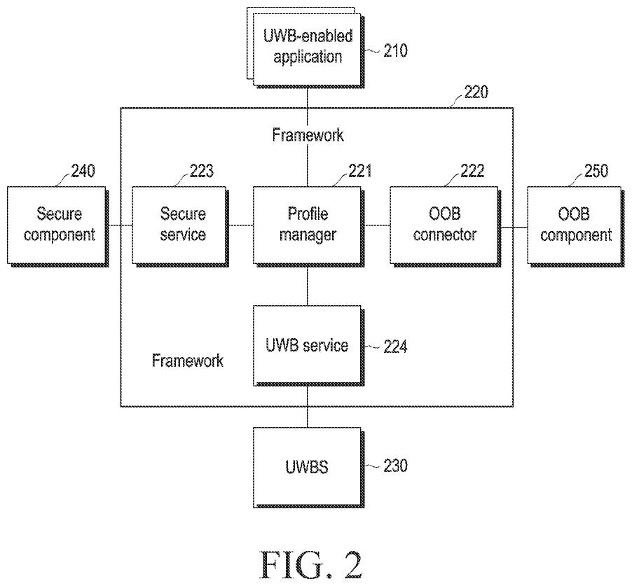

FIG. 2 illustrates an example configuration of a framework of a UWB device according to an embodiment of the disclosure.

The UWB device of FIG. 2 may be an example of the UWB device of FIG. 1.

Referring to FIG. 2, the Framework 220 may include, e.g., software components, such as Profile Manager 221, OOB Connector(s) 222, Secure Service 223 and/or UWB service 224.

The Profile Manager 221 may serve to manage profiles available on the UWB device. Profile may be a set of parameters required to establish communication between UWB devices. For example, a profile may include a parameter indicating which OOB secure channel is used, a UWB/OOB configuration parameter, a parameter indicating whether the use of a particular secure component is mandatory, and/or a parameter related to the file structure of the ADF. The UWB-enabled Application 210 may communicate with the Profile Manager 221 through the first interface (e.g., Framework (API)).

The OOB Connector 222 may serve to establish an OOB connection with another device. The OOB Connector 222 may handle an OOB step including a discovery step and/or a connection step. The OOB component (e.g., BLE component) 250 may be connected to the OOB connector 222.

The Secure Service 223 may play a role of interfacing with a Secure Component 240, such as SE or TEE.

The UWB Service 224 may perform a role of managing the UWBS 230. The UWB Service 224 may provide access to the UWBS 230 from the Profile Manager 221 by implementing the second interface.

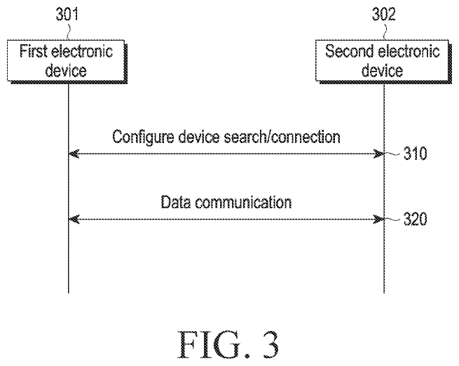

FIG. 3 illustrates a method for performing communication by a plurality of electronic devices according to an embodiment of the disclosure.

The first electronic device 301 and the second electronic device 302 of FIG. 3 may be, e.g., the UWB devices of FIG. 1 or 2.

Referring to FIG. 3, the first electronic device 301 and the second electronic device 302 may perform a device search/connection setup procedure 310 and a data communication procedure 320. The device search/connection setup procedure 310 and data communication procedure 320 may be managed or controlled by the MAC layer (entity) of the electronic device.

### (1) Device Search/Connection Setup Procedure

In the disclosure, the device search/connection setup procedure 310 may be a prior procedure performed before the data communication procedure 320. As an example, the device discovery/connection setup procedure 310 may be performed over OOB communication (channel), NB communication (channel), and/or UWB communication (channel).

The device search/connection setup procedure 310 may include at least one of the following operations.
Device discovery operation: An operation in which the electronic device searches for (discovers) another UWB devices. The device discovery operation may include an operation for transmitting/receiving an advertisement message. In the disclosure, the device discovery operation may be referred to as a discovery operation or an advertising operation.
Connection setup operation: An operation in which two electronic devices establish a connection. The connection setup operation may include an operation for transmitting/receiving a connection request message and a connection confirmation message. A connection (channel) established through the connection setup operation may be used to configure and control a UWB session for data communication. For example, parameters (e.g., UWB performance parameters (controllee performance parameters), UWB configuration parameters, session key-related parameters) for configuring a UWB session through a secure channel established through the connection setup operation may be negotiated between two electronic devices.

### (2) Data Communication Procedure

In the disclosure, the data communication procedure 320 may be a procedure for transmitting and receiving data using UWB communication. As an embodiment, the data communication procedure may be performed by UWB communication or NB communication.

The data communication procedure 320 may include at least one of the following operations.
UWB ranging operation: An operation in which the electronic device performs UWB ranging with another electronic device in a preset UWB ranging scheme (e.g., OWR, SS-TWR, DS-TWR scheme). As an embodiment, the UWB ranging operation may include a ToF measurement operation and/or an AoA measurement operation.

For example, the DS-TWR scheme may include some or all of the following steps.

Ranging Control Phase (RCP): A step in which a UWB controller transmits a UWB control message (e.g., a ranging control message (RCM)) to a UWB controller. Through this, the controller may control ranging and define ranging parameters.

Ranging Initiation Phase (RIP): A step in which a UWB initiator transmits a UWB initiation message (RIM) to a UWB responder. The ranging initiation message may be the first message transmitted to start a ranging exchange. As an embodiment, the UWB controller/initiator may transmit a ranging control message and a ranging initiation message through one message. For example, the UWB controller/initiator may transmit a ranging initiation message including a ranging control message.

Ranging Response Phase (RRP): A step in which a UWB responder transmits a UWB response message (e.g., a Ranging Response Message (RRM)) corresponding to a UWB initiation message to a UWB initiator.

Ranging Final Phase (RFP): A step in which a UWB initiator transmits a UWB final message (e.g., a Ranging Final Message (RFM)) to a UWB responder. The RFP may only be used in the case of double-sided two-way ranging (DS-TWR).

As an embodiment, the UWB TWR procedure may further include a Measurement Report Phase (MRP). The measurement report phase may be a phase in which electronic devices participating in UWB ranging exchange ranging information (e.g., ToF information/AoA information, etc.) and/or related service information. As an embodiment, the UWB message used in the measurement report phase may be a Measurement Report Message (MRM), a Ranging Result Report Message (RRRM), or a Control Update Message (CUM). As an embodiment, the MRM may be transmitted by being included in an RRM or RFM.
Transaction operation: An operation in which an electronic device exchanges service data with another electronic device.

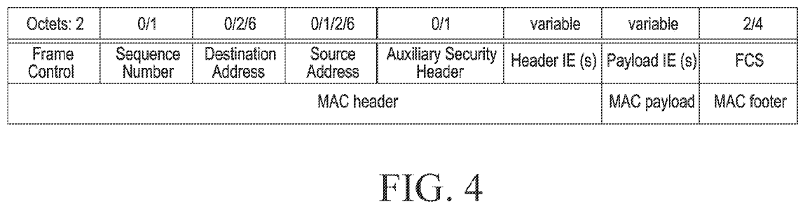

FIG. 4 illustrates a structure of a UWB MAC frame according to an embodiment of the disclosure.

In the embodiment of FIG. 4, the UWB MAC frame may follow the MAC frame structure of IEEE 802.15.4z, for example. In this disclosure, the UWB MAC frame may be simply referred to as a MAC frame or frame. As an embodiment, the UWB MAC frame may be used to transfer UWB data (e.g., UWB message, ranging message, control information, service data, application data, transaction data, etc.).

Referring to FIG. 4, the UWB MAC frame may include a MAC header (MHR), a MAC payload and/or a MAC footer (MFR).

### (1) MAC Header

The MAC header may include a Frame Control field, a Sequence Number field, a Destination Address field, a Source Address field, an Auxiliary Security Header field, and/or at least one Header IE field. According to an embodiment, some fields may not be included in the MAC header.

As an embodiment, the Frame Control field may include a Frame type field, a Security Enabled field, a Frame Pending field, an AR field, a PAN ID Compression field, a Sequence Number Suppression field, an IE Present field, a Destination Addressing Mode field, a Frame Version field, and/or a Source Addressing Mode field. Each field is described below.

The Frame Type field may indicate the frame type. As an embodiment, the frame type may include a data type and/or a multipurpose type.

The Security Enabled field may indicate whether an Auxiliary Security Header field exists. The Auxiliary Security Header field may include information required for security processing.

The Frame Pending field may indicate whether the device transmitting the frame has more data for the recipient. In other words, the Frame Pending field may indicate whether there is a pending frame for the recipient.

The AR field may indicate whether acknowledgment for frame reception is required from the recipient.

The PAN ID Compression field may indicate whether the PAN ID field exists.

The Sequence Number Suppression field may indicate whether the Sequence Number field exists. The Sequence Number field may indicate the sequence identifier for the frame.

The IE Present field may indicate whether the Header IE field and the Payload IE field are included in the frame.

The Destination Addressing Mode field may indicate whether the Destination Address field may include a short address (e.g., 16 bits) or an extended address (e.g., 64 bits). The Destination Address field may indicate the address of the recipient of the frame.

The Frame Version field may indicate the frame version. For example, the Frame Version field may be set to a value indicating IEEE std 802.15.4z-2020.

The Source Addressing Mode field may indicate whether the Source Address field exists, and if the Source Address field exists, whether the Source Address field includes a short address (e.g., 16 bits) or an extended address (e.g., 64 bits). The Source Address field may indicate the address of the originator of the frame.

### (2) MAC Payload

The MAC payload may include at least one Payload IE field. As an embodiment, the Payload IE field may include a Vendor Specific Nested IE. As an embodiment, the Payload IE field may include the Payload IE field of the UWB message, ranging message or control message.

### (3) MAC Footer

The MAC footer may include an FCS field. The FCS field may include a 16-bit CRC or a 32-bit CRC.

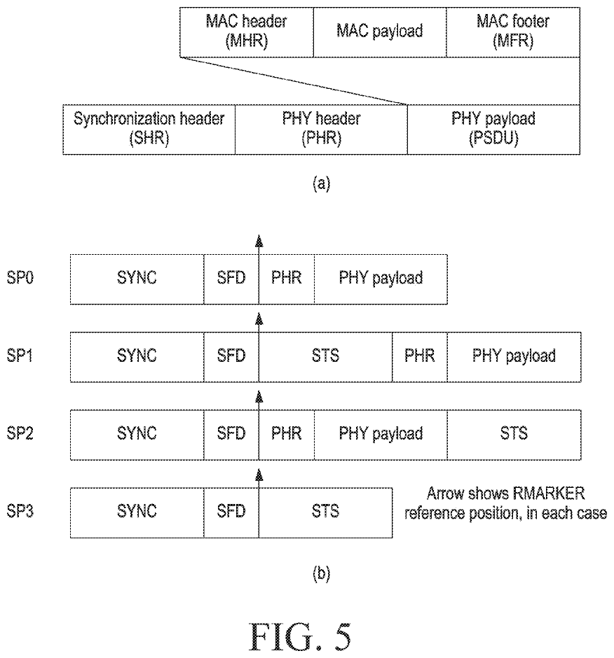

FIGS. 5A and 5B illustrate a structure of a UWB PHY packet according to an embodiment of the disclosure.

FIG. 5(a) illustrates an example structure of a UWB PHY packet to which the STS packet configuration is not applied, and FIG. 5(b) illustrates an example structure of a UWB PHY packet to which the STS packet configuration is applied. In the disclosure, the UWB PHY packet may be referred to as a PHY packet, a PHY PDU (PPDU), or a frame.

Referring to FIG. 5(a), the PPDU may include a synchronization header (SHR), a PHY header (PHR), and a PHY payload (PSDU). The PSDU may include a MAC frame. As shown in FIG. 4, the MAC frame may include a MAC header (MHR), a MAC payload and/or a MAC footer (MFR). In the disclosure, the synchronization header part may be referred to as a preamble, and the part including the PHY header and the PHY payload may be referred to as a data part.

The synchronization header may be used for synchronization for signal reception and may include a SYNC field and a start-of-frame delimiter (SFD).

The SYNC field may be a field including a plurality of preamble symbols used for synchronization between transmission/reception devices. The preamble symbol may be set through one of previously defined preamble codes.

The SFD field may be a field indicating the end of the SHR and the start of the data field.

The PHY header may provide information about the configuration of the PHY payload. For example, the PHY header may include information about the length of the PSDU, information indicating whether the current frame is an RFRAME, and the like.

Meanwhile, the PHY layer of the UWB device may include an optional mode to provide a reduced on-air time for high density/low power operation. In this case, the UWB PHY packet may include an encrypted sequence (i.e., STS) to increase the integrity and accuracy of the ranging measurement timestamp. An STS may be included in the STS field of the UWB PHY packet and be used for security ranging.

Referring to FIG. 5(b), in the case of STS packet (SP) setting 0 (SP0), the STS field is not included in the PPDU (SP0 packet). In the case of SP setting 1 (SP1), the STS field is positioned immediately after the Start of Frame Delimiter (SFD) field and before the PHR field (SP1 packet). In the case of SP setting 2 (SP2), the STS field is positioned after the PHY payload (SP2 packet). In the case of SP setting 3 (SP3), the STS field is positioned immediately after the SFD field, and the PPDU does not include the PHR and data field (PHY payload) (SP3 packet). In other words, in the case of SP3, the PPDU does not include the PHR and PHY payload.

In the embodiment of FIG. 5(b), each UWB PHY packet may include RMARKER for defining a reference time. RMARKER may be used to obtain the transmission time, reception time and/or time range of the ranging message (frame) in the UWB ranging procedure.

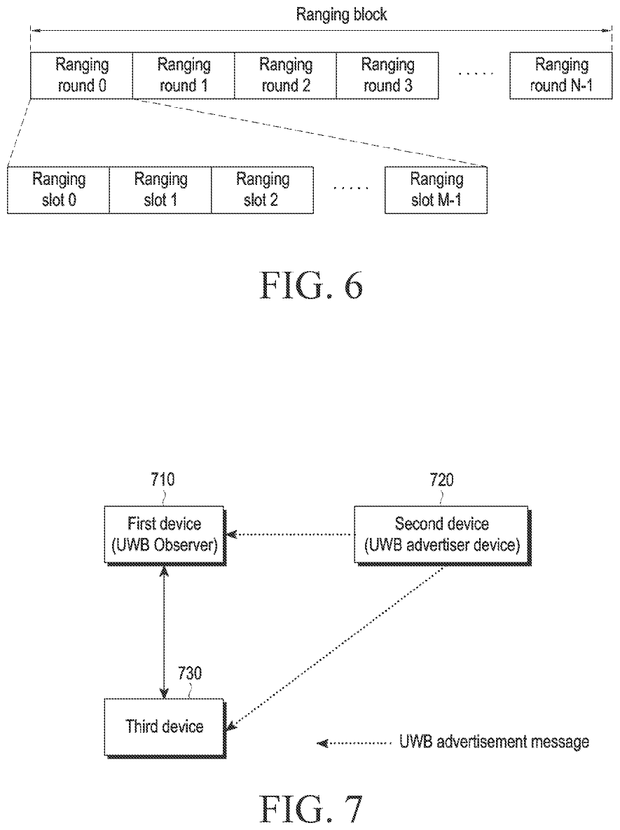

FIG. 6 illustrates an example of a structure of a ranging block and round used for UWB ranging according to an embodiment of the disclosure;

In this disclosure, the ranging block refers to a time period for ranging. The ranging round may be a period of sufficient duration to complete one entire range-measurement cycle (ranging cycle) in which a set of UWB devices participating in a ranging exchange involves. The ranging slot may be a sufficient period for transmission of at least one ranging frame (RFRAME) (e.g., ranging initiation/reply/final message, etc.).

As shown in FIG. 6, one ranging block may include at least one ranging round. Each ranging round may include at least one ranging slot.

When the ranging mode is a block-based mode, a mean time between contiguous ranging rounds may be a constant. Alternatively, when the ranging mode is an interval-based mode, the time between contiguous ranging rounds may be dynamically changed. In other words, the interval-based mode may adopt a time structure having an adaptive spacing.

The number and duration of slots included in the ranging round may be changed between ranging rounds.

In the disclosure, a ranging block, a ranging round, and a ranging slot may be abbreviated as a block, a round, and a slot.

Hereinafter, a method for providing a service initiation using a UWB OWR and a user gesture input will be described.

In the disclosure, the UWB OWR may be performed by using a UWB advertisement message (AoA measurement message) as a UWB OWR message, and the service initiation (activation) and user gesture input may be provided by using AoA information obtained using the UWB advertisement message.

### [UWB System Architecture for UWB OWR of the Disclosure]

FIG. 7 illustrates a system for providing a service initiation using a UWB OWR, and a user gesture input according to an embodiment of the disclosure.

Referring to FIG. 7, a system for providing a service initiation and user gesture input using a UWB OWR (hereinafter, UWB system) may include a first device 710, a second device 720, and/or a third device 730. In the disclosure, the first device 710 may be referred to as a first electronic device and a first UWB device, the second device 720 may be referred to as a second electronic device and a second UWB device, and the third device 730 may be referred to as a third electronic device and a third UWB device.

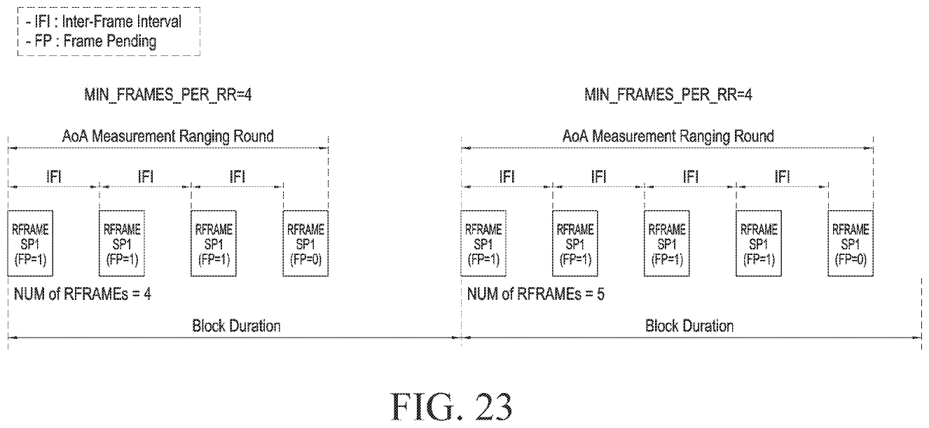

In the embodiment of FIG. 7, it is assumed that the second device 720 operates as a UWB advertiser device that transmits a UWB advertisement message, and the first device 710 and/or the third device 730 operate as UWB observer devices that receive the UWB advertisement message. An example of the UWB advertisement message may be the same as that exemplified in FIG. 23 and Tables 1 to 3 to be described later.

### <Operation of Second Device>

The second device 720 may transmit (or broadcast) a UWB advertisement message. As an embodiment, the second device 720 may transmit the UWB advertisement message at a preconfigured period (advertisement period).

As an embodiment, a UWB advertisement message may include information about the advertisement period (advertisement period information). For example, the advertisement period information may be information that explicitly indicates the advertisement period or information used to obtain the advertisement period. For example, the advertisement period information may be the inter-frame interval information/field of Table 2 described later. This advertisement period may be related to the AoA sampling rate. In the disclosure, the advertisement period may be referred to as an advertisement message transmission period, and the advertisement period information may be referred to as advertisement message transmission period information.

As an embodiment, a UWB advertisement message may include application data (application payload data). For example, as an embodiment, the application data may include the context (e.g., a redirection address or content) of the service to be advertised through the UWB advertisement message. The application data may be used to identify/initiate a related service.

As an embodiment, a UWB advertisement message may be used by a UWB observer device to obtain/estimate AoA information for the received UWB advertisement message. The AoA information may include AoA elevation information indicating an AoA elevation value and/or AoA azimuth information indicating an AoA azimuth value. The AoA information thus obtained may be used to identify/provide initiation of the corresponding service and/or user gesture input related to the corresponding service.

### <Operation of First Device>

The first device 710 may receive a UWB advertisement message and perform operations for a service initiation and/or a user gesture input based on the UWB advertisement message.

As an embodiment, the first device 710 may obtain AoA information based on the UWB advertisement message. For example, the first device 710 may measure an AoA elevation value and/or an AoA azimuth value based on the UWB advertisement message.

As an embodiment, the first device 710 may further obtain a received signal strength indicator (RSSI) for the UWB advertisement message.

As an embodiment, the first device 710 may determine a scheme for identifying a user gesture (motion) based on the UWB advertisement message. For example, the first device 710 may determine a scheme for identifying a user gesture (user gesture input) based on advertisement period information included in the UWB advertisement message.

The scheme for identifying a user gesture input may be either a first scheme (option 1) that uses only the UWB OWR based on the UWB advertisement message to identify the user gesture input, or a second scheme (option 2) that uses the UWB TWR with another device (e.g., the third device 730) together with the UWB OWR based on the UWB advertisement message to identify the user gesture input. The second scheme may be a scheme that further uses an auxiliary measurement using the UWB TWR compared to the first scheme.

In case of the first scheme, AoA information (first AoA information) obtained based on a UWB advertisement message may be used to identify a user gesture input. Meanwhile, in case of the second scheme, AoA information (first AoA information) obtained based on a UWB advertisement message, along with distance information and/or AoA information (second AoA information) obtained based on a UWB TWR with another electronic device may be used to identify a user gesture input. In the disclosure, the first AoA information may be referred to as Advertisement (Adv.) AoA information, and the second AoA information may be referred to as TWR AoA information.

As an embodiment, the first device 710 may identify an advertisement period (or interval) based on advertisement period information included in a UWB advertisement message and compare the advertisement period with a preconfigured threshold. As an embodiment, the threshold may be related to a sampling rate (or period) required for user gesture sensing.

As an embodiment, when the advertisement period is less than a preconfigured threshold (e.g., when the advertisement period is faster than the sampling rate), the first device 710 may select the first scheme as a scheme for identifying the user gesture input. When the advertisement period is greater than the preconfigured threshold (e.g., when the advertisement period is slower than the sampling rate), the first device 710 may select the second scheme as a scheme for identifying the user gesture input.

As an embodiment, the first device 710 may identify a user gesture input according to the first scheme or the second scheme and perform an operation corresponding to the user gesture input.

### <Operation of Third Device>

Like the first device 710, the third device 730 may operate as a UWB observer device. In this case, like the first device 710, the third device 730 may obtain AoA information based on the UWB advertisement message received by the third device 730.

In addition, the third device 730 may perform UWB TWR with the first device 710 to assist in identifying the user gesture input of the first device 710. As an embodiment, the UWB TWR (UWB TWR session) between the first device 710 and the third device 730 may be started and terminated by the first device 710, but the embodiment is not limited thereto.

### Embodiment Using the First Scheme (Option 1) of the Disclosure

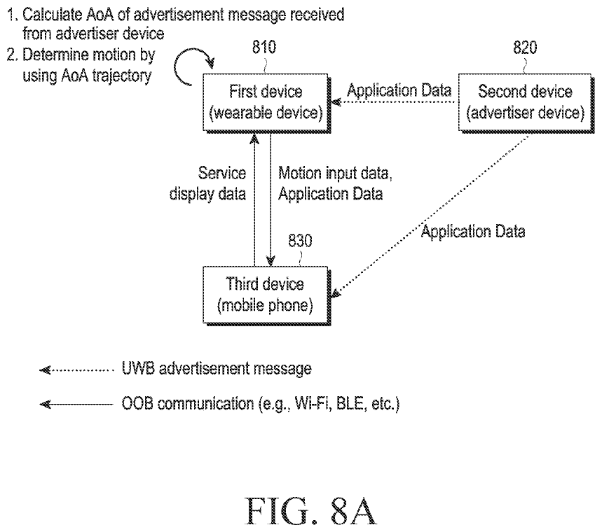

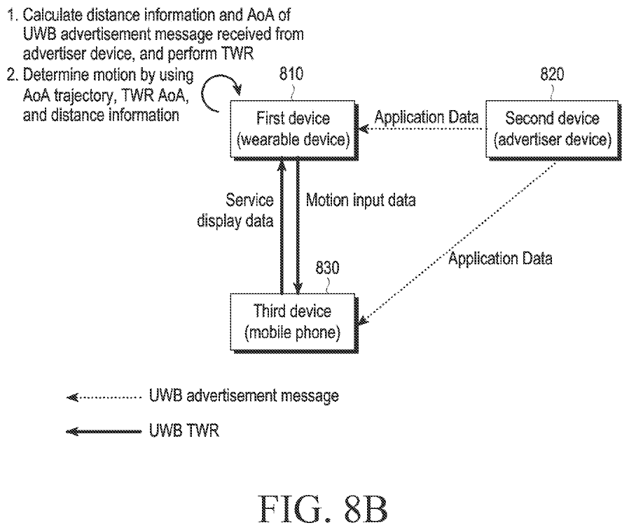

FIG. 8A illustrates a method for an electronic device to identify a user gesture input by using a first scheme according to an embodiment of the disclosure.

As described above, the first scheme may be a scheme that uses only the UWB OWR based on a UWB advertisement message to identify a user gesture input. The first scheme may be distinguished from the second scheme that uses a UWB OWR based on a UWB advertisement message and a UWB TWR with another device to identify a user gesture input.

In the embodiment of FIG. 8A, a first device (device #1) 810, a second device (device #2) 820, and a third device (device #3) 830 may be examples of the first device 710, the second device 720, and the third device 830 of FIG. 7, respectively.

The first device 810 is an electronic device that operates as a UWB observer device, and may be, for example, a user's wearable device, but the embodiment is not limited thereto.

The second device 820 is an electronic device that operates as a UWB advertiser device, and may be, for example, a fixed device (e.g., a kiosk), but the embodiment is not limited thereto.

The third device 830 is an electronic device that operates as a UWB observer device, and may be, for example, a user's mobile phone, but the embodiment is not limited thereto.

### <UWB Advertiser Device>

Referring to FIG. 8A, the second device 820 may transmit (or broadcast) a UWB advertisement message. For example, the second device 820 may transmit the UWB advertisement message at a preconfigured period (transmission period). As an embodiment, the UWB advertisement message may include application data.

### <UWB Observer Device>

The first device 810 and the third device 830 may receive one or more UWB advertisement messages.

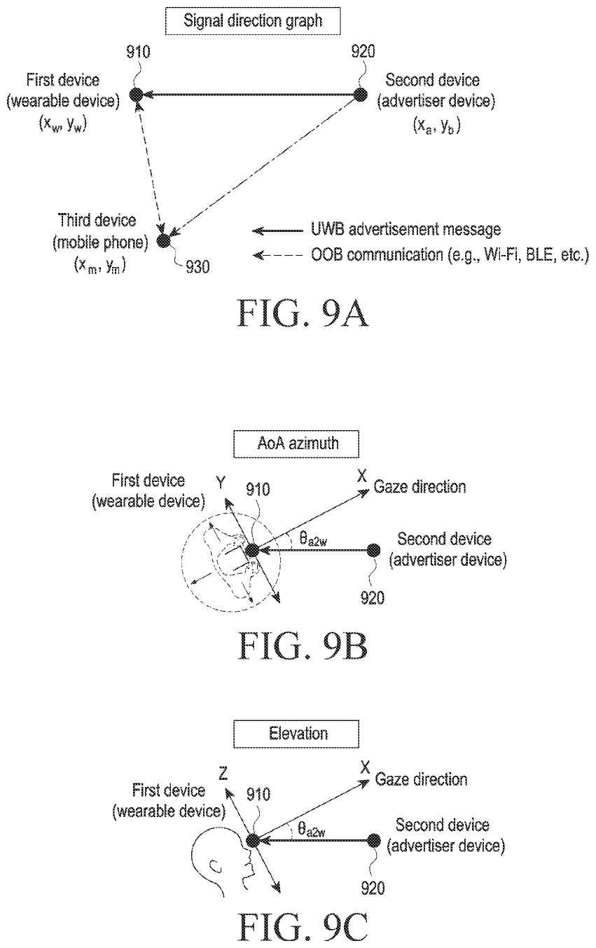

The first device 810 may obtain AoA information (AoA azimuth/AoA elevation) for the received one or more UWB advertisement messages. In addition, the first device 810 may determine a user motion (gesture) by using an AoA trajectory obtained based on the AoA information. The first device 810 may identify a user gesture input by using an AoA trajectory. An example of a method in which the first device 810 obtains AoA information based on the received UWB advertisement message according to the first scheme and identifies a user gesture input based on the obtained AoA information will be described below with reference to FIG. 9.

The first device 810 may communicate with the third device 830 through OOB communication (e.g., Wi-Fi, BLE, etc.). For example, the first device 810 may transmit application data and/or motion input data to the third device 830. The motion input data may include data of a user gesture input identified by the first device 810. The first device 810 may receive service data from the third device 830. The service data may include service data (e.g., service display data) related to the user gesture input.

The embodiment of FIG. 8A describes an example that the first device 810 and the third device 830 exchange data with each other through OOB communication. In this case, power consumption may be reduced compared to a case of exchanging data through in-band communication. However, the above-described embodiment is not limited thereto. For example, the first device 810 and the third device 830 may exchange all or part of the above-described data through in-band communication, if necessary.

### Embodiment Using the Second Scheme (Option 2) of the Disclosure

FIG. 8B illustrates a method for an electronic device to identify a user gesture input by using a second scheme according to an embodiment of the disclosure.

As described above, the second scheme may be a scheme that uses a UWB OWR based on a UWB advertisement message and a UWB TWR with another device to identify a user gesture input. The second scheme may be distinguished from the first scheme using only the UWB OWR based on the UWB advertisement message to identify the user gesture input.

In the embodiment of FIG. 8B, the first device (device #1) 810, the second device (device #2) 820, and the third device (device #3) 830 may be examples of the first device 710, the second device 720, and the third device 830 of FIG. 7, respectively.

The first device 810 is an electronic device that operates as a UWB observer device, and may be, for example, a user's wearable device, but the embodiment is not limited thereto.

The second device 820 is an electronic device that operates as a UWB advertiser device, and may be, for example, a fixed device (e.g., a kiosk), but the embodiment is not limited thereto.

The third device 830 is an electronic device that operates as a UWB observer device, and may be, for example, a user's mobile phone, but the embodiment is not limited thereto.

### <UWB Advertiser Device>

Referring to FIG. 8B, the second device 820 may transmit (or broadcast) a UWB advertisement message. For example, the second device 820 may transmit the UWB advertisement message at a preconfigured period (transmission period). As an embodiment, the UWB advertisement message may include application data.

### <UWB Observer Device>

The first device 810 and the third device 830 may receive one or more UWB advertisement messages.

The first device 810 may obtain AoA information (AoA azimuth/AoA elevation) for the received one or more UWB advertisement messages.

The first device 810 may communicate with the third device 830 through in-band communication. For example, the first device 810 may perform a UWB TWR with the third device 830. Through the UWB TWR, the first device 810 may obtain distance information and/or second AoA information (AoA azimuth/AoA elevation). The distance information may provide information about a distance between the first device 810 and the third device 830.

As an embodiment, when the first device 810 is an initiator (or controller) for a TWR, AoA azimuth and AoA elevation for an RRM may be measured. Alternatively, when the third device 830 is a responder (or controller) for a TWR, AoA azimuth and AoA elevation for an RIM message may be measured, and information about AoA azimuth and AoA elevation measured through an RRRM may be transmitted to the first device 810.

As another embodiment, when the first device 810 is a responder (or controller) for a TWR, AoA azimuth and AoA elevation for the RIM message may be measured.

The first device 810 may determine a user motion (gesture) by using the trajectory obtained based on first AoA information, second AoA information, and/or distance information. The first device 810 may identify a user gesture input by using the obtained trajectory.

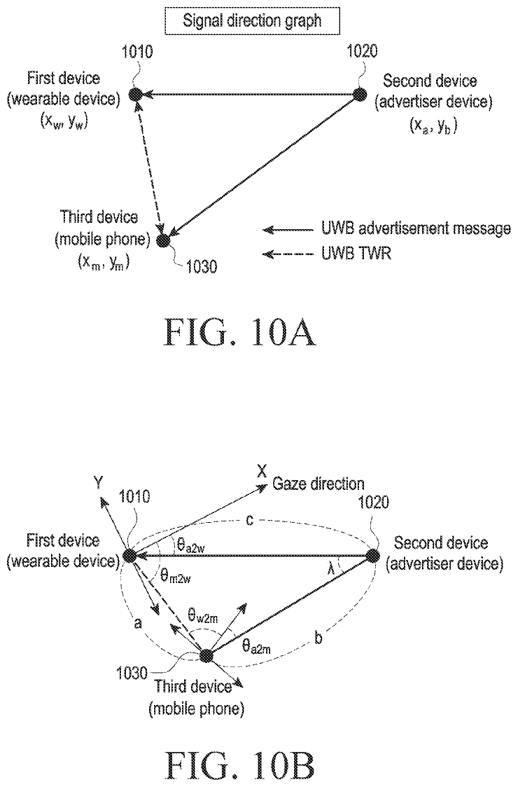

An example of a method in which the first device 810 obtains first AoA information, second AoA information, and distance information based on the received UWB advertisement message according to the second scheme, and identifies a user gesture input based on the obtained information will be described below with reference to FIG. 10.

The first device 810 may transmit motion input data to the third device 830 through in-band communication. For example, the first device 810 may transmit motion input data to the third device 830 through a UWB message (e.g., RFM, etc.). The motion input data may include data of a user gesture input identified by the first device 810.

The first device 810 may receive service data from the third device 830 through in-band communication. For example, the first device 810 may receive service data from the third device 830 through a UWB message. The service data may include service data (e.g., service display data) related to a user gesture input.

### Example of First Scheme (Option 1)

FIGS. 9A, 9B and 9C illustrate a method for an electronic device to identify a user gesture input, based on AoA information according to a first scheme according to an embodiment of the disclosure.

As described above, the first scheme may be a scheme that uses only the UWB OWR based on a UWB advertisement message to identify a user gesture input. The first scheme may be distinguished from the second scheme that uses a UWB OWR based on a UWB advertisement message and a UWB TWR with another device to identify a user gesture input.

In the embodiments of FIGS. 9A, 9B, and 9C, a first device (device #1) 910, a second device (device #2) 920, and a third device (device #3) 930 may be examples of the first device 810, the second device 820, and the third device 830 of FIG. 8A, respectively.

In the embodiments of FIGS. 9A, 9B, and 9C, for convenience of explanation, the gaze direction (reference direction) of the user wearing the first device 910 is assumed to be the X-axis, the horizontal axis of the first device is assumed to be the Y-axis, and the vertical axis of the first device is assumed to be the Z-axis.

FIG. 9A illustrates an example of a signal direction graph on the XY plane according to the first scheme.

Referring to FIG. 9A, coordinates on the XY plane of the first electronic device 910 may be expressed as (Xw, Yw), coordinates on the XY plane of the second electronic device 920 may be expressed as (Xm, Ym), and coordinates on the XY plane of the third electronic device 930 may be expressed as (Xa, Ya). The UWB advertisement message (input signal) is transmitted from the second electronic device 920 in the direction of the first electronic device 910.

FIG. 9B illustrates an example of an AoA azimuth value obtained according to the first scheme.

Referring to FIG. 9B, the first device 910, which is a UWB observer device, may measure/calculate an AoA azimuth value θ_{a2w} for a UWB advertisement message received from the second device 920 which is a UWB advertiser device. The AoA azimuth value θ_{a2w} may be a relative angle between the gaze direction (X axis) of a user wearing the first device 910 and the direction in which a UWB advertisement message (input signal) projected on the XY plane is received. Meanwhile, in the disclosure, the AoA azimuth may be expressed as a (+) sign when the signal transmission device is located on the left side with respect to the reference direction, and as a (−) sign when located on the right side, but the opposite case is also possible.

FIG. 9C illustrates an example of an AoA elevation value obtained according to the first scheme.

Referring to FIG. 9C, the first device 910, which is a UWB observer device, may measure/calculate an AoA elevation value Φ_{a2w} for a UWB advertisement message received from the second device 920 which is a UWB advertiser device. The AoA elevation value Φ_{a2w} may be a relative angle between the XY plane of the first device 910 and the direction in which the UWB advertisement message (input signal) is received. Meanwhile, in the disclosure, the AoA elevation may be expressed as a (+) sign when the signal transmission device is located above the XY plane, and as a (−) sign when located below the XY plane, but the opposite case is also possible.

The first device 910 may analyze the change (trajectory) of the AoA azimuth value and the AoA leveling value (θ_{a2w}, Φ_{a2w}) for periodically received UWB advertisement messages, and identify the user gesture input based on the analysis result. For example, when the pattern of changes in the AoA azimuth value and the AoA elevation value matches (or maps) the pattern of the predefined user gesture input, the first device 910 may identify that the user's motion corresponds to the user gesture input.

When identifying a user gesture input, the first device 910 may transmit data of the user gesture input to the third device 930. As an embodiment, the first device 910 may transmit data of the user gesture input to the third device 930 through OOB.

In the above-described embodiment of FIG. 9, the first scheme may be used to identify a user gesture input. In this case, since the UWB TWR is not used to identify the user gesture input, and only the UWB OWR based on the UWB advertisement message is used, the electronic device may identify the user gesture input faster and with less power compared to the second scheme.

### Example of Second Scheme (option 2)

FIGS. 10A and 10B illustrate a method for an electronic device to identify a user gesture input, based on AoA information according to a second scheme according to an embodiment of the disclosure.

As described above, the second scheme may be a scheme that uses a UWB OWR based on a UWB advertisement message and a UWB TWR with another device to identify a user gesture input. The second scheme may be distinguished from the first scheme that uses only the UWB OWR based on a UWB advertisement message to identify a user gesture input.

In the embodiments of FIGS. 10A and 10B, a first device (device #1) 1010, a second device (device #2) 1020, and a third device (device #3) 1030 may be examples of the first device 810, the second device 820, and the third device 830 of FIG. 8B, respectively.

In the embodiments of FIGS. 10A and 10B, for convenience of explanation, the gaze direction (reference direction) of the user wearing the first device 1010 is assumed to be the X-axis, the horizontal axis of the first device is assumed to be the Y-axis, and the vertical axis of the first device is assumed to be the Z-axis.

FIG. 10A illustrates an example of a signal direction graph on the XY plane according to the second scheme.

Referring to FIG. 10A, coordinates on the XY plane of the first electronic device 1010 may be expressed as (Xw, Yw), coordinates on the XY plane of the second electronic device 1020 may be expressed as (Xm, Ym), and coordinates on the XY plane of the third electronic device 1030 may be expressed as (Xa, Ya). The UWB advertisement message (input signal) is transmitted from the second electronic device 1020 in the direction of the first electronic device 1010 and from the second electronic device 1020 in the direction of the third electronic device 1030. UWB messages (e.g., RIM, RRM, RFM, etc.) for UWB TWR may be exchanged between the first electronic device 1010 and the third electronic device 1030.

FIG. 10B illustrates an example of an AoA information and distance information obtained according to the second scheme.

Referring to FIG. 10B, the first device 1010, which is a UWB observer device, may measure/calculate an AoA azimuth value θ_{a2w} for a first UWB advertisement message received from the second device 1020 which is a UWB advertiser device. The AoA azimuth value θ_{a2w} may be a relative angle between the gaze direction (X axis) of a user wearing the first device 1010 and the direction in which the first UWB advertisement message (input signal) projected on the XY plane is received. An example of the measurement of the AoA azimuth value θ_{a2w} may be the same as that illustrated in FIG. 9B.

In addition, the first device 1010, which is a UWB observer device, may measure/calculate an AoA elevation value Φ_{a2w} for a UWB advertisement message received from the second device 1020 which is a UWB advertiser device. The AoA elevation value Φ_{a2w} may be a relative angle between the XY plane and the direction in which the UWB advertisement message (input signal) is received. An example of the measurement of the AoA elevation value Φ_{a2w} may be the same as that illustrated in FIG. 9C.

In addition, the third device 1030, which is a UWB observer device, may measure/calculate an AoA azimuth value θ_{a2w} for a second UWB advertisement message received from the second device 1020 which is a UWB advertiser device. The AoA azimuth value θ_{a2w} may be a relative angle between the reference direction (e.g., an axis orthogonal to the display of the third device 1030) of the third device 1030 and the direction in which a second UWB advertisement message (second input signal) projected on the XY plane is received. The measured AoA azimuth value θ_{a2w} in this way may be included in the UWB message and transmitted to the first device 1010.

In addition, the first device 1010 may exchange UWB messages (UWB TWR messages) for the UWB TWR with the third device 1030.

In this case, the first device 1010 may measure/calculate an AoA azimuth value θ_{a2w} for a UWB TWR message (e.g., RIM or RRM) received from the third device 1030. The AoA azimuth value θ_{a2w} may be a relative angle between the gaze direction (X axis) of a user wearing the first device 1010 and the direction in which a UWB TWR message (input signal) projected on the XY plane is received. In addition, the first device 1010 may measure/calculate an AoA elevation value Φ_{a2w} for a UWB TWR message (e.g., RIM or RRM) received from the third device 1030. The AoA elevation value Φ_{a2w} may be a relative angle between the XY plane and the direction in which a UWB TWR message is received.

The third device 1030 may measure/calculate an AoA azimuth value θ_{a2w} for a UWB TWR message (e.g., RIM or RRM) received from the first device 1010. The AoA azimuth value θ_{a2w} may be a relative angle between the reference direction of the third device 1030 (e.g., an axis orthogonal to the display of the third device 1030) and the direction in which a UWB TWR message (input signal) projected on the XY plane is received. The measured AoA azimuth value θ_{a2w} in this way may be included in the UWB TWR message (e.g., RRRM) and transmitted to the first device 1010.

The first device 910 may analyze the change (trajectory) of first AoA information (θ_{a2w}, Φ_{a2w}) obtained based on the UWB OWR and second AoA information (θ_{a2w}, Φ_{a2w}) obtained based on the UWB TWR, and identify the user gesture input based on the analysis result. For example, when the pattern of changes in the first AoA information and the second AoA information matches the pattern of the predefined user gesture input, the first device 1010 may identify that the user's motion corresponds to the user gesture input.

When identifying a user gesture input, the first device 1010 may transmit data of the user gesture input to the third device 1030. As an embodiment, the first device 910 may transmit data of the user gesture input to the third device 930 through In-band.

In the above-described embodiment of FIG. 10, the second scheme may be used to identify a user gesture input. In this case, since the UWB TWR is used together with the UWR OWR to identify the user gesture input, the advertisement period for the UWB OWR is slower than the speed required for user gesture sensing, making it difficult to accurately identify the user gesture input with only the UWR OWR.

Meanwhile, when the second scheme is used, the mobility of the first device 1010 and the third device 1030 may be estimated based on the result of the OWR and the result of the TWR.

For example, as shown in FIG. 10B, the locations of the first device 1010, the second device 1020, and the third device 1030 form a triangle on the same plane (reference plane (XY plane)). In this case, a represents the distance between the first device 1010 and the third device 1030 on the reference plane, b represents the distance between the third device 1030 and the second device 1020 on the reference plane, and c represents the distance between the second device 1020 and the first device 1010 on the reference plane.

Meanwhile, the internal angle of the corresponding triangle may be obtained by using the AoA azimuth value obtained based on the UWR OWR and the AoA elevation value obtained based on the UWB TWR. This may be illustrated in Equation 1 below.

$$\begin{matrix}[ Equation 1 ] & \\ \vert {θ}_{m 2 w} - {θ}_{a 2 w} \vert + \vert {θ}_{w 2 m} - {θ}_{a 2 m} \vert + λ = 180 & \end{matrix}$$

Meanwhile, a may be obtained by the result of UWB TWR (e.g., the ToF value obtained by DS-TWR), and b and c may be obtained through Equation 2 below.

$$\begin{matrix}[ Equation 2 ] & \\ 1. a = b \cdot cos ∠ ( \vert {∠θ}_{w 2 m} - {∠θ}_{a 2 m} \vert ) + c \cdot cos ∠ ( \vert {∠θ}_{m 2 w} - {∠θ}_{a 2 w} \vert ) & [ First Cosine rule ]\end{matrix}$$

$$2. {b}^{2} = {a}^{2} + {c}^{2} - 2 ac \cdot cos ∠ ( \vert {∠θ}_{m 2 w} - {∠θ}_{a 2 w} \vert ) \qquad [ Second Cosine rule ]$$

$${c}^{2} = {b}^{2} + {c}^{2} - 2 bc \cdot cos ∠ ( \vert {∠θ}_{w 2 m} - {∠θ}_{a 2 m} \vert ) \qquad [ Second Cosine rule ]$$

$$From two equations of 2 , - is as follows , \qquad 3.$$

$${b}^{2} - {c}^{2} = {c}^{2} - {b}^{2} - 2 a ( b \cdot cos ∠ ( \vert {∠θ}_{w 2 m} - {∠θ}_{a 2 m} \vert ) - c \cdot cos ∠ ( \vert {∠θ}_{m 2 w} - {∠θ}_{a 2 w} \vert ) )$$

$${b}^{2} - {c}^{2} - a ( b \cdot cos ∠ ( \vert {∠θ}_{w 2 m} - {∠θ}_{a 2 m} \vert ) - c \cdot cos ∠ ( \vert {∠θ}_{m 2 w} - {∠θ}_{a 2 w} \vert ) ) = 0$$

$$When equation is substituted to equation , \qquad 4.$$

$${b}^{2} - {c}^{2} - ( b \cdot cos ∠ ( \vert {∠θ}_{w 2 m} - {∠θ}_{a 2 m} \vert ) + c \cdot cos ∠ ( \vert {∠θ}_{m 2 w} - {∠θ}_{a 2 w} \vert ) ) ( b \cdot cos ∠ ( \vert {∠θ}_{w 2 m} - {∠θ}_{a 2 m} \vert ) - c \cdot cos ∠ ( \vert {∠θ}_{m 2 w} - {∠θ}_{a 2 w} \vert ) ) = 0$$

$${b}^{2} ( 1 - {cos}^{2} ∠ ( \vert {∠θ}_{w 2 m} - {∠θ}_{a 2 m} \vert ) ) - {c}^{2} ( 1 - {cos}^{2} ∠ ( \vert {∠θ}_{m 2 w} - {∠θ}_{a 2 w} \vert ) ) = 0$$

$$In equation , the relative formula of b and c is obtained below , \qquad 5.$$

$$b = \pm ( \frac{sin ∠ ( \vert {∠θ}_{m 2 w} - {∠θ}_{a 2 w} \vert )}{sin ∠ ( \vert {∠θ}_{w 2 m} - {∠θ}_{a 2 m} \vert )} ) c$$

$$Values of b and c may be obtained because ∠ ( \vert {∠θ}_{m 2 w} - {∠θ}_{a 2 w} \vert ) , \\ ∠ ( \vert {∠θ}_{w 2 m} - {∠θ}_{a 2 m} \vert ) , \qquad 6.$$

$$and a are obtained by OWR and TRW .$$

In this case, based on the values (or relative ratios) of b and c and the UWB TWR results, whether the first device 1010 and the third device 1030 move and/or a relative location may be estimated. Meanwhile, it is assumed that the location of the second device 1020 is fixed.

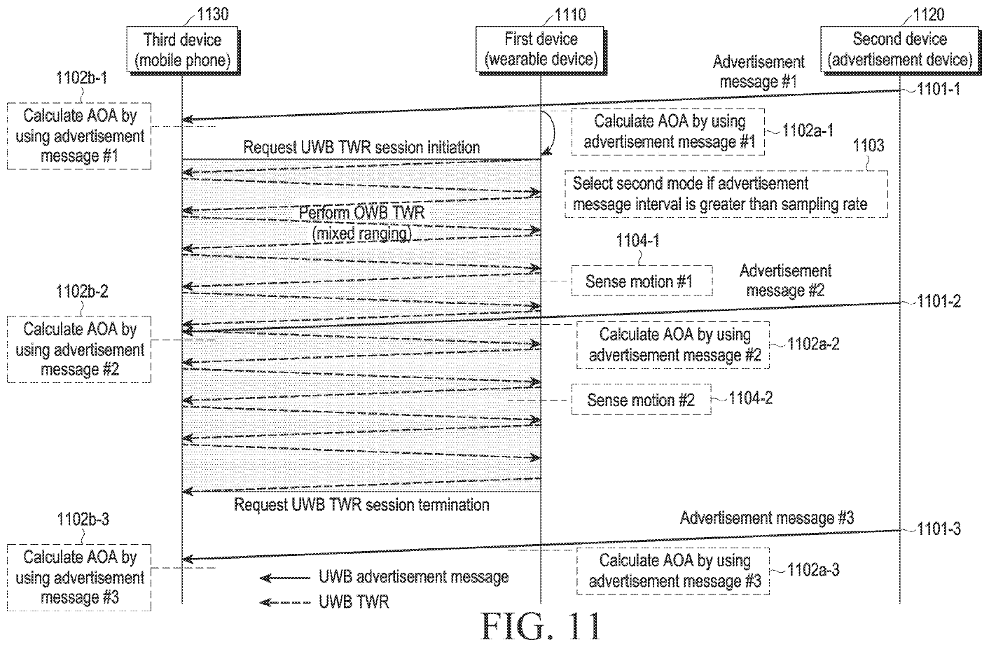

FIG. 11 illustrates an exemplary procedure of a method for an electronic device to identify a user gesture input, based on AoA information according to a second scheme according to an embodiment of the disclosure.

As described above, the second scheme may be a scheme that uses a UWB OWR based on a UWB advertisement message and a UWB TWR with another device to identify a user gesture input. The second scheme may be distinguished from the first scheme that uses only the UWB OWR based on a UWB advertisement message to identify a user gesture input.

In the embodiments of FIG. 11, a first device (wearable device #1) 1110, a second device (advertiser device #2) 1120, and a third device (mobile device #3) 1130 may be examples of the first device 810, the second device 820, and the third device 830 of FIG. 8B, respectively.

### <First UWB Advertisement Message (Advertisement #1)>

Referring to FIG. 11, in operation 1101-1, the second device 1120 may broadcast a first UWB advertisement message, and the first device 1110 and the third device 1130 may receive the first UWB advertisement message. The first UWB advertisement message may be the first received UWB advertisement message.

In operations 1102a-1 and 1102b-1, the first device 1110 and the third device 1130 may calculate an AoA value based on the received first UWB advertisement message, respectively. The calculation of the AoA values of the first device 1110 and the third device 1130 may be referred to the description of FIGS. 9 and 10.

In operation 1103, the first device 1110 may determine whether to use the second scheme for user gesture identification. As an embodiment, the first device 1110 may determine whether to use the second scheme based on the advertisement interval (or advertisement period) of the UWB advertisement message. For example, the first device 1110 may compare the advertisement interval and the sampling rate (speed) of the UWB advertisement message, and determine to use the second scheme when the advertisement interval is greater than the sampling rate.

When the second scheme is used, a UWB TWR between the first device 1110 and the third device 1130 may be performed.

The UWB TWR may be started when a UWB TWR session start request is transmitted from the first device 1110 to the third device 1130. As an embodiment, when identifying that the second scheme is used in operation 1103, the first device 1110 may transmit the UWB TWR session start request.

The UWB TWR may be terminated when a UWB TWR session stop request is transmitted from the first device 1110 to the third device 1130.

In the above-described embodiment, it is disclosed that the UWB TWR session start request and the UWB TWR session stop request are transmitted by the first device 1110, but the embodiment is not limited thereto. For example, the UWB TWR session start request and/or the UWB TWR session stop request may be transmitted by the third device 1130.

As an embodiment, the UWB TWR used in the second scheme may be a hybrid ranging scheme. The hybrid ranging scheme may be a scheme in which scheduling-based ranging and contention-based ranging are used together.

As an embodiment, the UWB TWR used in the second scheme may be a DS-TWR scheme.

In operation 1104-1, the first device 1110 may sense the user's motion (motion #1) based on the result of the UWR OWR and the result of the UWB TWR. Through this, the first device 1110 may identify the user gesture input.

### <Second UWB Advertisement Message (Advertisement #2)>

In operation 1101-2, the second device 1120 may broadcast a second UWB advertisement message, and the first device 1110 and the third device 1130 may receive the second UWB advertisement message.

In operations 1102a-2 and 1102b-2, the first device 1110 and the third device 1130 may calculate an AoA value based on the received second UWB advertisement message, respectively. The calculation of the AoA values of the first device 1110 and the third device 1130 may be referred to the description of FIG. 10.

As described above, the UWB TWR may continue until the UWB TWR session stop request is transmitted from the first device 1110 to the third device 1130. Meanwhile, since the UWB advertisement message is received while the UWB TWR is not terminated, the first device 1110 does not need to determine again whether to use the second scheme for identifying the user gesture input.

In operation 1104-2, the first device 1110 may sense the user's motion (motion #2) based on the result of the UWR OWR and the result of the UWB TWR. Through this, the first device 1110 may identify the user gesture input.

### <Third UWB Advertisement Message (Advertisement #3)>

In operation 1101-3, the second device 1120 may broadcast a third UWB advertisement message, and the first device 1110 and the third device 1130 may receive the third UWB advertisement message.

In operations 1102a-3 and 1102b-3, the first device 1110 and the third device 1130 may calculate an AoA value based on the received third UWB advertisement message, respectively. The calculation of the AoA values of the first device 1110 and the third device 1130 may be referred to the description of FIG. 10.

Meanwhile, since the UWB advertisement message is received while the UWB TWR is terminated, the first device 1110 may determine again whether to use the first scheme or the second scheme for identifying the user gesture input, and perform operations for identifying the user gesture input according to the determined scheme.

### [Flowchart and Exemplary Operating Situation of First Scheme]

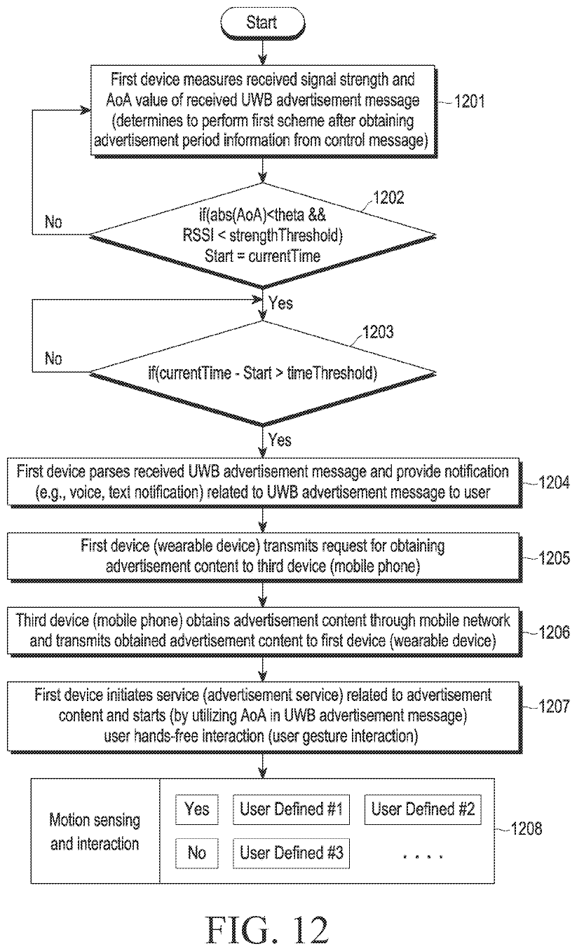

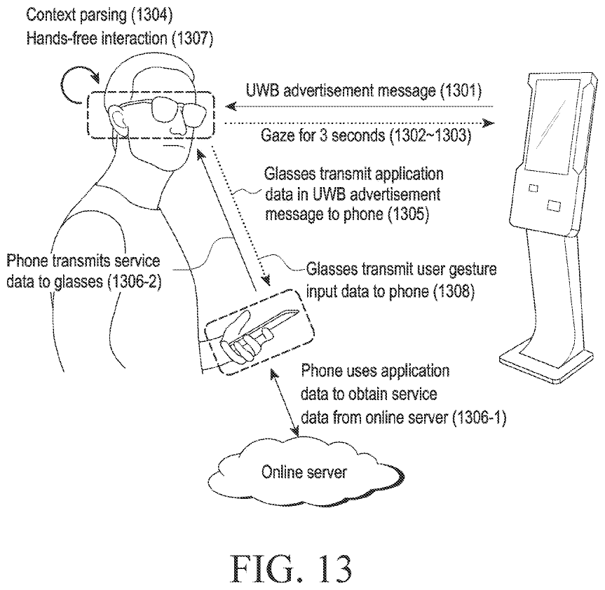

FIG. 12 illustrates a flowchart of a method for an electronic device to identify a user gesture input, based on AoA information according to a first scheme according to an embodiment of the disclosure. FIG. 13 illustrates an exemplary operation situation according to the method of FIG. 12.

As described above, the first scheme may be a scheme that uses only the UWB OWR based on a UWB advertisement message to identify a user gesture input. The first scheme may be distinguished from the second scheme that uses a UWB OWR based on a UWB advertisement message and a UWB TWR with another device to identify a user gesture input.

In embodiments of FIGS. 12 and 13, the wearable device, the advertiser device, and the mobile phone may be examples of the first device 810, the second device 820, and the third device 830 of FIG. 8A, respectively.

Referring to FIGS. 12 and 13, in operation 1201, the first device (wearable device) may receive a UWB advertisement message from the second device (advertisement device) and measure the received signal strength indicator (RSSI) and/or an AoA value of the received UWB advertisement message. For example, as shown in operation 1301, the first device may receive a UWB advertisement message from the second device.

Meanwhile, the first device may obtain advertisement period information included in the UWB advertisement message (or the control message), and determine to perform the first scheme (option 1) for identifying the user gesture input based on the advertisement period information. The determination of the scheme for identifying the user gesture input may be performed before or after measuring the AoA value.

The first device may identify whether there is a user's intention for initiating the service related to the UWB advertisement message. For example, the first device may continue to measure the AoA value based on periodically received UWB advertisement messages, and if the AoA value remains within a specific range for a specific period of time or longer, the first device may identify that there is a user's intention to initiate the service. An example of such an operation for identifying the user's intention may be as shown in operations 1202 and 1203 below.

In operation 1202, the first device may identify whether the AoA value is less than a preconfigured threshold (theta) and the received signal strength is less than a preconfigured strength threshold (strengthThreshold). When the AoA value is less than the preconfigured threshold (theta) and the received signal strength is less than the preconfigured strength threshold (strengthThreshold), the first device may configure the start time to the current time. Otherwise, the first device may perform operation 1201 again.

In operation 1203, the first device may determine whether a value obtained by subtracting the start time from the current time is greater than a time threshold (timeThreshold). When the value obtained by subtracting the start time from the current time is not greater than the time threshold, the first device may update the current time and perform operation 1203 again. That is, the operation may stay in operation 1203. When the value obtained by subtracting the start time from the current time is not greater than the time threshold, 1204 may proceed.

For example, as shown in operations 1302 and 1303, a user wearing the first device may gaze at the second device for a preconfigured time threshold (e.g., 3 seconds). In this case, both the conditions of operation 1202 and operation 1203 may be satisfied, and operation 1204 may proceed.

In operation 1204, the first device may parse the received UWB advertisement message and provide a notification (e.g., voice, text notification) related to the UWB advertisement message to the user. For example, as shown in operation 1304, the first device may parse the context of the UWB advertisement message.

In operation 1205, the first device may transmit a request for obtaining advertisement content to the third device (mobile phone). For example, as shown in operation 1305, the first device may transmit application data in the UWB advertisement message to the third device.

In operation 1206, the third device may obtain advertisement content through a mobile network and transmit the obtained advertisement content to the first device. For example, as shown in operation 1306-1, the third device may obtain service data from the server (online server) by using the received application data, and as shown in operation 1306-2, the third device may transmit the obtained service data to the first device.

In operation 1207, the first device may initiate a service (advertisement service) related to the advertisement content and start a user hands-free interaction (user gesture interaction). The user hands-free interaction may be performed by using AoA information obtained based on the UWB advertisement message. For example, as shown in operation 1307, the first device may start the hands-free interaction.

In operation 1208, the first device may perform motion sensing and interaction of the user. For example, the first device may identify a user gesture input and perform an operation corresponding to the user gesture input. As an embodiment, the user gesture input may include a ‘Yes’ input (a head nodding gesture), a ‘No’ input (a head shaking gesture), and/or a user defined input (user defined #1, #2, . . . , #3). For example, as shown in operation 1308, the first device may identify the user gesture input and transmit data of the user gesture input to the third device.

### [Flowchart and Exemplary Operating Situation of Second Scheme]

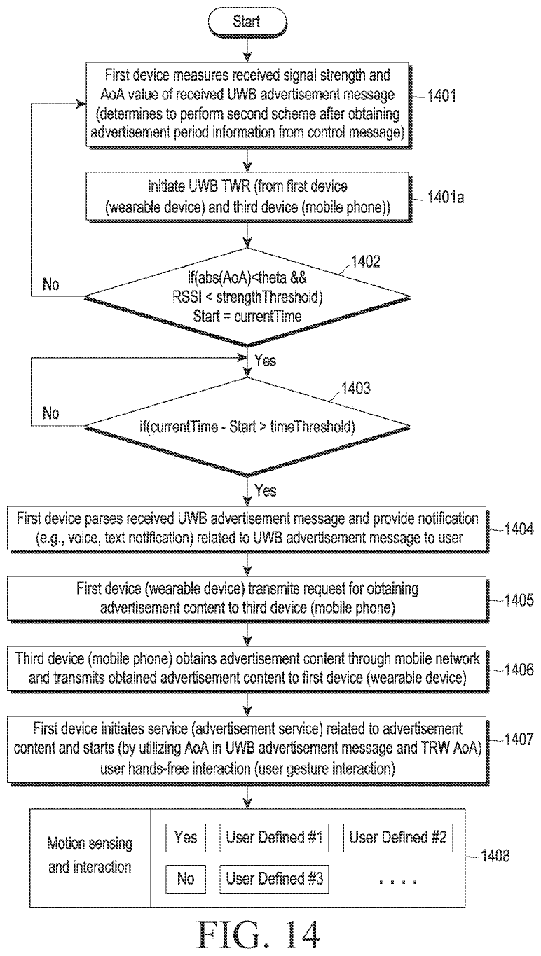

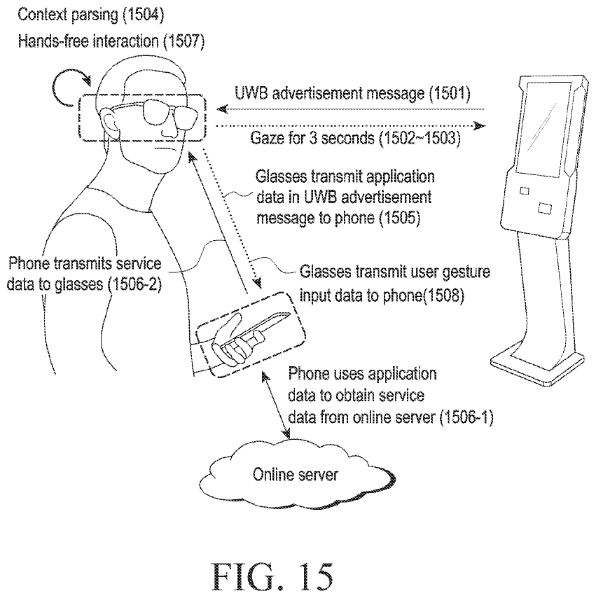

FIG. 14 illustrates a flowchart of a method for an electronic device to identify a user gesture input, based on AoA information according to a second scheme according to an embodiment of the disclosure. FIG. 15 illustrates an exemplary operation situation according to the method of FIG. 14.

As described above, the second scheme may be a scheme that a UWB OWR based on a UWB advertisement message and a UWB TWR with another device to identify a user gesture input. The second scheme may be distinguished from the first scheme that uses only the UWB OWR based on a UWB advertisement message to identify a user gesture input.

In embodiments of FIGS. 14 and 15, the wearable device, the advertiser device, and the mobile phone may be examples of the first device 810, the second device 820, and the third device 830 of FIG. 8B, respectively.

Referring to FIGS. 14 and 15, in operation 1401, the first device (wearable device) may receive a UWB advertisement message from the second device (advertisement device) and measure the received signal strength indicator (RSSI) and/or an AoA value of the received UWB advertisement message. For example, as shown in operation 1501, the first device may receive a UWB advertisement message from the second device.

Meanwhile, the first device may obtain advertisement period information included in the UWB advertisement message, and determine to perform the second scheme (option 1) for identifying the user gesture input based on the advertisement period information. The determination of the scheme for identifying the user gesture input may be performed before or after measuring the AoA value.

In operation 1401a, a UWB TWR may be started from the first device and the third device (mobile phone). As an embodiment, the UWB TWR may be started upon a UWB TWR session start request from the first device.

The first device may identify whether there is a user's intention for initiating the service related to the UWB advertisement message. For example, the first device may continue to measure the AoA value based on periodically received UWB advertisement messages, and if the AoA value remains within a specific range for a specific period of time or longer, the first device may identify that there is a user's intention to initiate the service. An example of such an operation for identifying the user's intention may be as shown in operations 1402 and 1403 below.

In operation 1402, the first device may identify whether the AoA value is less than a preconfigured threshold (theta) and the received signal strength is less than a preconfigured strength threshold (strengthThreshold). When the AoA value is less than the preconfigured threshold (theta) and the received signal strength is less than the preconfigured strength threshold (strengthThreshold), the first device may configure the start time to the current time. Otherwise, the first device may perform operation 1401 again.

In operation 1403, the first device may determine whether a value obtained by subtracting the start time from the current time is greater than a time threshold (timeThreshold). When the value obtained by subtracting the start time from the current time is not greater than the time threshold, the first device may update the current time and perform operation 1403 again. That is, the operation may stay in operation 1403. When the value obtained by subtracting the start time from the current time is not greater than the time threshold, 1404 may proceed.

For example, as shown in operations 1502 and 1503, a user wearing the first device may gaze at the second device for a preconfigured time threshold (e.g., 3 seconds). In this case, both the conditions of operation 1402 and operation 1403 may be satisfied, and operation 1404 may proceed.

In operation 1404, the first device may parse the received UWB advertisement message and provide a notification (e.g., voice, text notification) related to the UWB advertisement message to the user. For example, as shown in operation 1504, the first device may parse the context of the UWB advertisement message.

In operation 1405, the first device may transmit a request for obtaining advertisement content to the third device (mobile phone). For example, as shown in operation 1505, the first device may transmit application data in the UWB advertisement message to the third device.

In operation 1406, the second device may obtain advertisement content through a mobile network and transmit the obtained advertisement content to the first device. For example, as shown in operation 1506-1, the third device may obtain service data from the server (online server) by using the received application data, and as shown in operation 1506-2, the third device may transmit the obtained service data to the first device.

In operation 1407, the first device may initiate a service (advertisement service) related to the advertisement content and start a user hands-free interaction (user gesture interaction). The user hands-free interaction may be performed by using AoA information obtained based on the UWB advertisement message and AoA information obtained through a UWB TWR. For example, as shown in operation 1507, the first device may start the hands-free interaction.

In operation 1408, the first device may perform motion sensing and interaction of the user. For example, the first device may identify a user gesture input and perform an operation corresponding to the user gesture input. As an embodiment, the user gesture input may include a ‘Yes’ input (a head nodding gesture), a ‘No’ input (a head shaking gesture), and/or a user defined input (user defined #1, #2, . . . , #3). For example, as shown in operation 1508, the first device may identify the user gesture input and transmit data of the user gesture input to the third device.

### Embodiment of Registering User Gesture

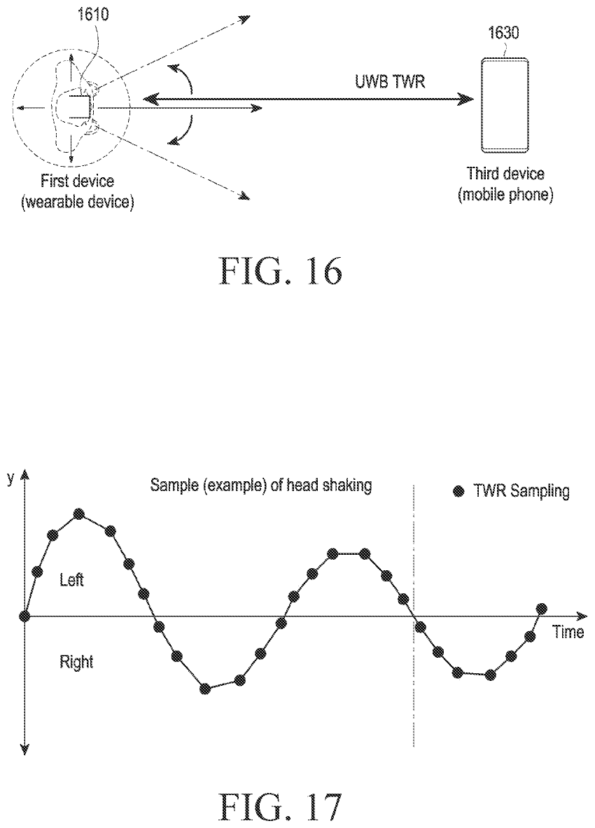

FIG. 16 illustrates a method for an electronic device to register a user-defined gesture according to an embodiment of the disclosure. FIG. 17 illustrates a graph for AoA information obtained according to the method for registering the user-defined gesture of FIG. 16.

In the embodiment of FIG. 16, a method of registering a user-defined gesture (customized gesture) using a first device 1610 as a wearable device and a third device 1630 as a mobile device is exemplarily described. However, the embodiment is not limited thereto, and it is possible to register a user-defined gesture by using another type of device. For example, user-defined gesture registration using the first device 1610, which is a wearable device, and the second device, which is a UWB advertiser device, is also possible.

Referring to FIG. 16, the first device 1610 may use a UWB TWR with the third device 1630 to register a user gesture.

An exemplary procedure for registering a user gesture using the UWB TWR may include at least one of the following steps.

Step 1: The third device 1630 may enter a mode for registering a user gesture (user gesture registration mode).

Step 2: A UWB TWR session between the first device 1610 and the third device 1630 may be started. That is, the UWB TWR may be started.

Step 3: The user of the first device 1610 may wear the first device 1610 and be located at a specific distance based on the third device 1630 fixed at an arbitrary location. That is, the first device 1610 may be located at a specific distance from the third device 1630.

Step 4: When a specific distance condition is satisfied, the third device 1630 may proceed with a process for registering a user gesture through a preconfigured scheme (e.g., a voice service scheme). For example, the third device 1630 may provide voice notifications such as “Specify the gesture name”, “Specify the gesture action”, “Start recording the gesture. 3 2 1 Start!”, “n times completed”, etc.

Step 5: The third device 1630 may record AoA information obtained from the first device 1610 based on the UWB TWR. For example, when recording gestures, the third device 1630 may continuously record UWB TWR-based AoA information received from the first device 1610.

An example of UWB TWR-based AoA information recorded according to a preconfigured TWR sampling period (rate) may be as shown in FIG. 17.

In the embodiment of FIG. 17, it is assumed that a user gesture input to be registered is a head shaking gesture input (“No” input). Referring to FIG. 17, AoA information (e.g., an AoA azimuth value) corresponding to the user gesture input to be registered may be continuously recorded according to a preconfigured TWR sampling period (rate). For example, as shown in FIG. 17, when a user wearing a wearable device shakes his or her head to the left from a reference direction, a (+) AoA Azimuth value may be recorded, and when the head is shaken to the right from the reference direction, a (−) AoA azimuth value may be recorded.

Step 6: The recorded AoA information (or a graph (trajectory) of AoA information) may be used as a reference for identifying the user gesture input. For example, when a user motion corresponding to the graph of the registered AoA information is identified, the electronic device may identify that the corresponding user gesture input has been input. The recorded AoA information (or the graph of AoA information) may be stored in a mapping table for the user gesture.

### Embodiment of Multiple UWB Advertisers

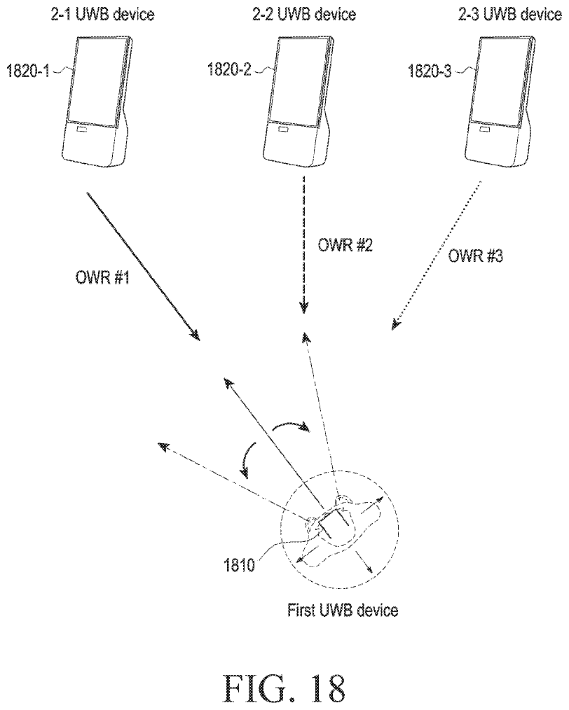

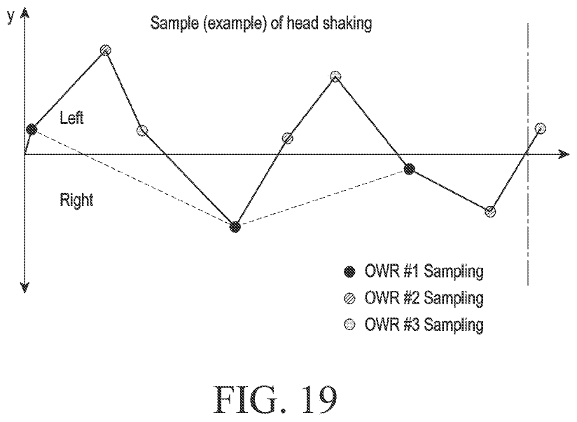

FIG. 18 illustrates a method for an electronic device to identify a user gesture input by using AoA information obtained based on an OWR message received from a plurality of UWB advertisement devices according to an embodiment of the disclosure. FIG. 19 illustrates a graph for AoA information obtained according to a method for identifying the user gesture input of FIG. 18.

The embodiment of FIG. 18 may be an extended embodiment of the first scheme for identifying the user input described above.

In the embodiment of FIG. 18, for convenience of explanation, a method for a first UWB device (or a first device) 1810, which is a UWB observer device, to identify a user gesture input by using AoA information obtained based on an OWR message (e.g., a UWB advertisement message) received from a plurality of UWB advertiser devices, which are a 2-1 UWB device (or a 2-1 device) 1820-1, a 2-2 UWB device (or a 2-2 device) 1820-2, and a 2-3 UWB device (or a 2-3 device) 1820-3, is exemplarily described. However, the embodiment is not limited thereto, and it is also possible for a UWB observer device to identify a user gesture input by using AoA information obtained based on an OWR messages (e.g., a UWB advertisement message) received from a different number (e.g., 2, 4, etc.) of UWB advertiser devices.

An exemplary procedure for identifying a user gesture using a UWB OWR may include at least one of the following steps.

Step 1: The first device 1810 may receive a OWR message from a plurality of second devices (the 2-1 device 1820-1 to the 2-3 device 1820-3), respectively.

Step 2: The first device 1810 may obtain and record AoA information based on each received OWB message.

Step 3: The first device 1810 may record the amount of change in AoA information for each second device in time order based on the AoA information for each second device using OWR messages (or AoA measurement messages) received from each second device of a ranging block (or ranging round) at a specific point in time. An example of a graph representing the amount of change in AoA information for each second device obtained from the ranging block at a specific point in time may be as shown in FIG. 19.

In an embodiment of FIG. 19, it is assumed that the user gesture input is a head shaking gesture input (“No” input). Referring to FIG. 19, the amount of change in AoA information for each second device in a ranging block (or round) at a specific point in time may be recorded in time order.

Step 4: The first device 1810 may identify a user gesture input corresponding to the sampling data by using the amount of change in AoA information according to the recorded time as sampling data. For example, if a graph connecting sampling values such as the pattern of the graph illustrated in FIG. 19 in time order is identified, the electronic device may identify a user gesture input corresponding to a head shaking input.

Step 5: The first device 1810 may transmit data of a user gesture input to the third device, which is a mobile device, through the OOB.

### Exemplary Motion Sensing Scenario for Multiple Mobile Devices

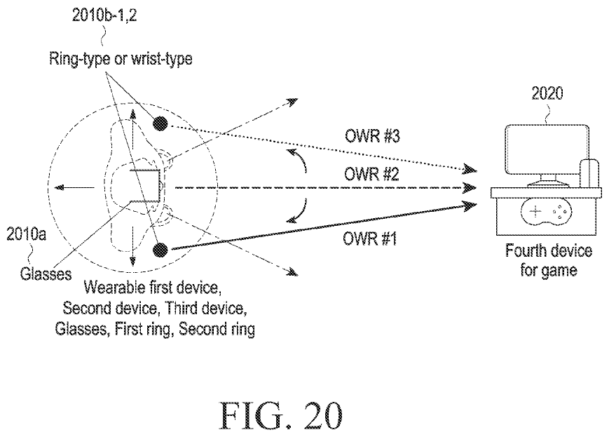

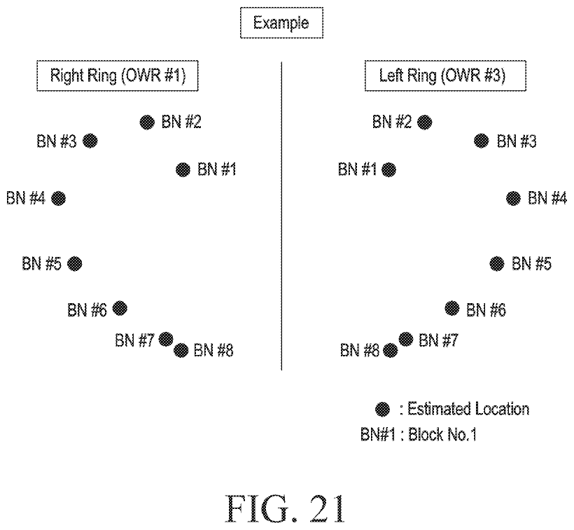

FIG. 20 illustrates a motion sensing scenario using a UWB OWR according to an embodiment of the disclosure. FIG. 21 illustrates a graph of AoA information collected using the motion sensing scenario of FIG. 20.

In the embodiment of FIG. 20, it is assumed that an OWR message is transmitted from a plurality of mobile devices (e.g., wearable devices) to a single fixed device (e.g., a game device). In addition, it is assumed that the first mobile device 2010a is a wearable device (e.g., wearable glasses) worn on the user's head, and it is assumed that a plurality of second mobile devices 2010b-1 and 2 are ring-type or wrist-type wearable devices worn on both wrists or two fingers of the user.

Referring to FIG. 20, each of the first mobile device 2010a and the plurality of second mobile devices 2010b-1 and 2010b-2 may transmit an OWB message (AoA measurement message). For example, the first mobile device 2010a may broadcast a second OWR message OWR #2, the 2-1 mobile device 2010b-1 may broadcast a first OWB message OWR #1, and the 2-2 mobile device 2010b-2 may broadcast a third OWR message OWR #3.

The fixed device (e.g., a game device) 2020 may receive the first OWB message, the second OWB message, and the third OWB message.

For example, in a scenario that recognizes a hand motion of a virtual reality (VR) game, when both hands wearing the second mobile devices 2010b-1 and 2010b-2 move together to draw a single gesture (e.g., a heart gesture), the second mobile devices 2010b-1 and 2010b-2 may transmit an OWR message for AoA measurement to the fixed device 2020, respectively. In this case, the fixed device 2020 may use AoA information collected in a specific ranging block (or round), for example, a UWB AoA measurement ranging round (or block), for two-dimensional motion sensing. An example of a graph representing a value of AoA information collected in each UWB AoA measurement ranging block (or round) may be as shown in FIG. 21.

FIG. 21 may be a graph illustrating relative locations of the second mobile devices 2010b-1 and 2010b-2 estimated in 2D space by using values of AoA information calculated for each UWB AoA measurement ranging block (or round) by using OWB messages transmitted from the second mobile devices 2010b-1 and 2010b-2 worn on both hands, respectively. Specifically, the left drawing of FIG. 21 corresponds to a graph showing the relative locations of the wearable device 2010b-1 in 2D space by using AoA values obtained for each ranging block based on the OWR message (OWR #1) transmitted from the wearable device 2010b-1 worn on the right hand, and the right drawing of FIG. 21 corresponds to a graph showing the relative locations of the wearable device 2010b-1 in 2D space by using AoA values obtained for each ranging block based on the OWR message (OWR #2) transmitted from the wearable device 2010b-2 worn on the left hand. In the case of embodiments of FIGS. 20 and 21, the structures of the ranging block and/or ranging round used to transmit OWR messages in the two second mobile devices 2010b-1 and 2010b-2 is the same and may be synchronized with each other. An example of the ranging block and/or ranging round to transmit OWR messages may be as shown in FIG. 23 to be described later.

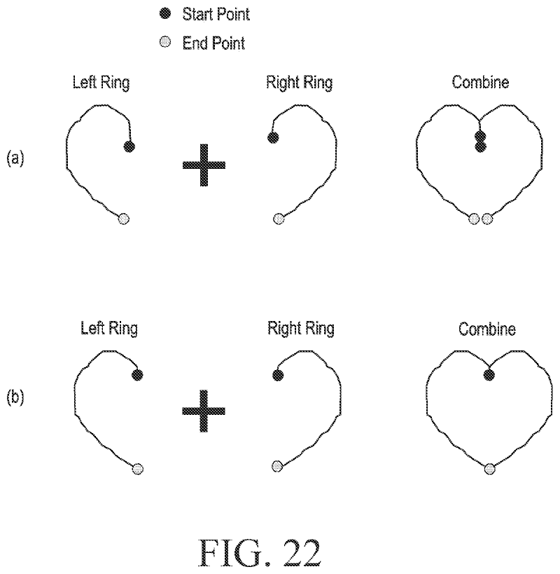

FIGS. 22A and 22B illustrate diagrams comparing a graph of AoA information obtained based on a motion sensor according to an embodiment of the disclosure with a graph of AoA information obtained based on an OWR.

In the embodiments of FIGS. 22A and 22B, it is assumed that a plurality of wearable devices are worn on each of a user's hands (e.g., two fingers or both wrists), and the user wearing the plurality of wearable devices moves both hands together to draw a single gesture (e.g., a heart gesture).

FIG. 22A shows a relative location estimation graph obtained when motion is sensed by using a motion sensor (e.g., an IMU sensor).

When a motion sensor is used, motion data may be collected from each wearable device worn on both hands, and after synchronizing the motion data, motion sensing may be performed. In this case, the subject synchronizing the motion data may be one of the wearable devices or another device. However, since it is difficult to accurately synchronize the motion data, as shown in FIG. 22A, the entire graph combining the estimated location graphs has a relatively large error.

FIG. 22B shows a relative location estimation graph obtained when motion is sensed by using a UWB OWR.

When a UWB OWR is used, the structures of the ranging block and/or ranging round used to transmit OWR messages in the related devices are identical to each other and are synchronized with each other, so no separate synchronization operation is required. In addition, as shown in FIG. 22b, since ranging blocks of the same structure that are synchronized with each other are used for the UWB OWR, the entire graph combining the estimated location graphs has a small error compared to using a motion sensor. Through this, accurate identification of the user gesture input is possible. An example of the ranging block/round structure for transmitting an OWR message may be as shown in FIG. 23 to be described later.

### Embodiment of Structure of Ranging Block/Round Used for OWR for AoA Measurement and Format of OWR Message

FIG. 23 illustrates an example of a structure of a ranging block used for a UWB OWR according to an embodiment of the disclosure.

The structure of the ranging block used for the UWB OWR of FIG. 23 may be an example of the structure of the ranging block used for the UWB OWR described above in FIGS. 1 to 23. Meanwhile, the structures of the ranging blocks used in a plurality of related devices (e.g., a pair of wearable devices (e.g., ring 1, 2), a pair of wearable devices (e.g., ring 1, 2), and another wearable device (e.g., glasses) may be the same and may be synchronized with each other.

In FIG. 23, for convenience of description, it is assumed that the minimum number of RFRAMEs per ranging round (AoA measurement ranging round) for AoA measurement is 4 (MIN_FRAMES_PER_RR-4), but embodiments are not limited thereto, and different numbers of RFRAMEs may be transmitted in the AoA measurement ranging round.

Referring to FIG. 23, a plurality of RFRAMEs may be transmitted by a single UWB advertiser device during ranging blocks.

As an embodiment, one ranging block may include only one AoA measurement ranging round.

As an embodiment, in the AoA measurement ranging round, the first RFRAME may be transmitted at the beginning of the ranging round.

As an embodiment, a UWB advertise device may configure the AoA measurement message (UWB advertisement message) based on configuration information of the minimum frames (MIN_FRAMES_PER_RR) per ranging round and the inter-frame interval configuration information.

The MIN_FRAMES_PER_RR configuration information may indicate the minimum number of AoA measurement messages (i.e., RFRAMEs) transmitted by the UWB advertisement device in the ranging block. Information about the number of AoA measurement messages (i.e., RFRAMEs) transmitted by the UWB advertisement device in the ranging round (AoA measurement ranging round) may be included in the AoA measurement message.

When one or more AoA measurement messages are transmitted by the UWB advertisement device in a ranging round, the transmission interval between two consecutive AoA measurement messages may be the same as the value indicated by the inter-frame interval configuration information. The inter-frame interval configuration information may be included in the AoA measurement message.

When the UWB observer device receives an AoA measurement message in a ranging round, the UWB observer device may identify how many AoA measurement messages have been transmitted by the UWB advertise device in the corresponding ranging round and the transmission interval, based on the number of RRAMEs (NUM of RFRAMEs) and inter-frame interval configuration information included in the AoA measurement message.

The UWB advertisement device may include application data in the AoA measurement message and transmit the same. As an embodiment, the application data may include the context (e.g., a redirection address or content) of the service to be advertised.

The application data may be included in one or more data messages IE. The data message IE may be included in the AoA measurement message. The UWB advertise device may set a maximum size of the data message IE in the AoA measurement message. The first data message IE may be included in the first RFRAME. The last RFRAME (RFRAMEs) may not include the data message IE.

As shown in FIG. 23, when receiving the last data message IE of the application data, the UWB observer device may switch the value of the frame pending (FramePending) field of the MAC header (MHR) to 0.

An example of the AoA measurement message (i.e., an OWR message for AoA measurement) may be shown in Table 1 below.

TABLE 1

| | Size | |
|---|---|---|
| Parameter | (bits) | Notes |
| Vendor OUI | 24 | 0x5A18FF |
| UWB Message ID | 4 | 0x7 = OWR Message |
| OWR Message | 4 | 0x5: AoA Measurement Message |
| Type | | |
| OWR Message | X | This field shall follow the specification |
| Type-dependent | | under respective OWR Message Type |
| Payload | | Payload IE fields defined in the |
| | | following subsections |

Referring to Table 1, the AoA measurement message, like another OWR message, may include three common fields (vendor OUI field, UWB message ID field, and OWR message type field), and may include a Payload IE field (OWR Message Type-dependent Payload) configured depending on the OWR message type field. An example of the Payload IE field of the AoA measurement message may be shown in Table 2 below.

TABLE 2

| | Size | |
|---|---|---|
| Parameter | (bits) | Notes |
| Message Control | 8 | Configuration of the message |
| Inter-Frame | 8 | Interval between the RFRAMES transmitted |
| Interval | | in the ranging block in the unit of 1200 |
| | | RSTU (=1 ms) |
| Block Index | 16 | Block index of the current ranging block |
| Block Duration | 16 | Block duration in the units of 1200 RSTU |
| | | (=1 ms) |

Referring to Table 2, the Payload IE field of the AoA measurement message may a message control field indicating configuration of a message, an inter-frame interval field indicating an interval between RFRAMEs transmitted in a ranging block, a block index field indicating a block index of the current ranging block (i.e., a ranging block in which the AoA measurement message or the RFRAME of the AoA measurement message is transmitted), and/or a block duration field indicating the block duration. RFRAMEs transmitted in a ranging block may have the same value of the block index field. An example of the message control field within the Payload IE field of the AoA measurement message may be as shown in Table 3 below.

TABLE 3

| | Size | |
|---|---|---|
| Parameter | (bits) | Notes |
| Number of | 4 | The number of RFRAMEs that are transmitted in |
| RFRAMEs | | the same ranging round in order to reduce the |
| | | deviation of AoA values measured by FiRa |
| | | Devices |
| RFU | 4 | Reserved for future use |

Referring to Table 3, the message control field may include a RFRAME number field. The RFRAME number field may indicate the number of RFRAMEs transmitted in the same ranging round. The value of the RFRAME number field may be equal to or greater than the value of MIN_FRAMES_PER_RR. The UWB advertiser device may transmit as many RFRAMEs as indicated by the RFRAME number field. In this case, two consecutive RFRAME number fields may be determined by the inter-frame interval field. The UWB observer device may identify the number of RFRAMEs in the corresponding ranging round, based on the value of the RFRAME number field included in the first AoA message of the ranging round.

A plurality of RFRAMEs in the ranging round may be used to reduce the deviation of the AoA measurement value measured by the UWB device.

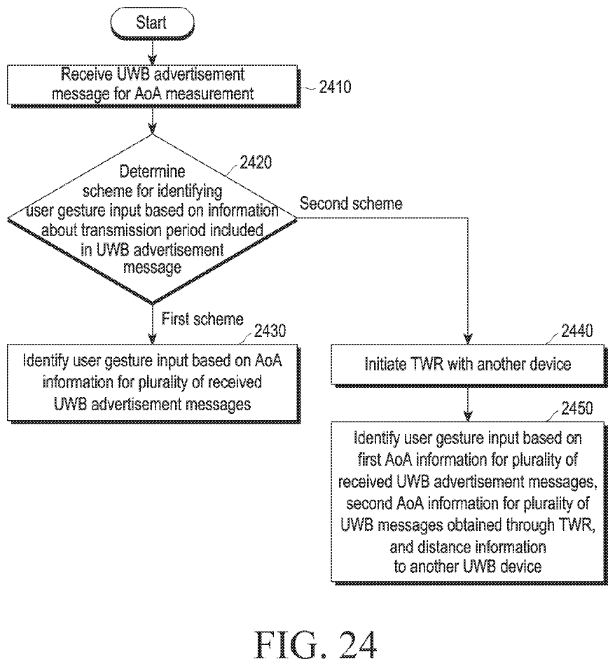

FIG. 24 is a flowchart illustrating a method for a UWB device to identify a user gesture input by using an OWR according to an embodiment of the disclosure.

In the embodiment of FIG. 24, the UWB device may be the first device (UWB observer device) of FIG. 8A or FIG. 8B.

Referring to FIG. 24, in operation 2410, the UWB device may receive a UWB advertisement message (AoA measurement message) for AoA measurement. As an embodiment, the UWB device may receive a periodically broadcasted UWB advertisement message from a UWB advertiser device. As an embodiment, the UWB advertisement message is a message for the UWB OWR and may include information about a transmission period of the UWB advertisement message.

In operation 2420, the UWB device may determine a scheme for identifying a user gesture input based on information about a transmission period included in the UWB advertisement message. As an embodiment, the scheme for identifying a user gesture input may be either a first scheme (option 1) using only the UWB OWR based on the UWB advertisement message to identify the user gesture input or a second scheme (option 2) using the UWB TWR with another device (e.g., the third device 730) together with UWB OWR based on UWB advertisement messages to identify the user gesture input.

When the scheme for identifying the user gesture input is the first scheme, operation 2430 may proceed. In operation 2430, the UWB device may identify the user gesture input based on AoA information for a plurality of received UWB advertisement messages. As an embodiment, the AoA information may include information indicating AoA azimuth and information indicating AoA elevation.

When the scheme for identifying the user gesture input is the second scheme, operation 2440 may proceed. In operation 2440, the UWB device may initiate a TWR with another UWB device. As an embodiment, the other UWB device may be a UWB observer device.

In operation 2450, the UWB device may identify the user gesture input based on the first AoA information for a plurality of received UWB advertisement messages, the second AoA information for a plurality of UWB messages obtained through the TWR, and distance information to another UWB device.

As an embodiment, the UWB device may identify whether there is a user intent for initiating a service related to the UWB advertisement message based on the received AoA information for the plurality of UWB advertisement messages.

As an embodiment, the UWB advertisement message may be periodically broadcast from a fixed UWB device.

As an embodiment, the UWB advertisement message may include application data related to a service to be initiated by the UWB advertisement message. When the scheme for identifying the user gesture input is the first scheme, the UWB device may transmit application data to the other UWB device.

As an embodiment, the UWB advertisement message may be transmitted in a single ranging round configured for the AoA measurement in the ranging block.

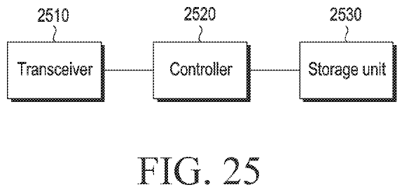

FIG. 25 is a device diagram of a UWB device according to an embodiment of the disclosure.

In the embodiment of FIG. 25, the UWB device may perform a function of a UWB advertiser device or a UWB observe device.

Referring to FIG. 25, the UWB device may include a transceiver 2510, a controller 2520, and a storage unit 2530. In the disclosure, the controller may be defined as a circuit, an application-specific integrated circuit, or at least one processor.

The transceiver 2510 may transmit and receive a signal to and from another entity. The transceiver 2510 may transmit and receive data to and from another UWB device by using, for example, UWB communication or OOB communication (e.g., BLE communication).

The controller 2520 may control the overall operation of the electronic device according to an embodiment proposed in the disclosure. For example, the controller 2520 may control the signal flow between respective blocks to perform the operation according to the flow chart described above. Specifically, the controller 2520 may control, for example, an operation for providing a service initiation and user gesture input method using the UWB OWR described with reference to FIGS. 1 to 24.

The storage unit 2530 may store at least one of information transmitted and received via the transceiver 2510 and information generated via the controller 2520. For example, for the method described with reference to FIGS. 1 to 24, the storage unit 2530 may store, for example, information and data necessary to provide a service initiation and user gesture input method using the UWB OWR.

In the above-described specific embodiments, the components included in the disclosure are expressed in singular or plural forms depending on specific embodiments proposed. However, the singular or plural expressions are selected to suit the presented situation for the convenience of explanation, and the disclosure is not limited to the singular or plural components, and even if the components are expressed in the plural form, they may be composed of the singular form, or even if the components are expressed in the singular form, they may be composed of the plural forms.

Although the detailed description of the disclosure has described specific embodiments, it is obvious that various modifications are possible within the scope of the disclosure. Therefore, the scope of the disclosure should not be limited to the described embodiments, but should be determined by the scope of the patent claims described below as well as the equivalents of the scope of the patent claims.

1-15. (canceled)

16. A method of a first ultra-wide band (UWB) device, comprising:
receiving, from a second UWB device, a first UWB advertisement message for measurement of an angle of arrival (AoA) with a third UWB device, wherein the first UWB advertisement message is for UWB one-way ranging (OWR) and includes information about a transmission period of the first UWB advertisement message; and
determining, based on the information about the transmission period, a scheme for identifying a user gesture input of the first UWB device,
wherein the scheme for identifying the user gesture input includes a first scheme using the UWB OWR to identify the user gesture input or a second scheme using both the UWB OWR and UWB two-way ranging (TWR) with the third UWB device to identify the user gesture input.

17. The method of claim 16, wherein determining the scheme for identifying the user gesture input of the first UWB device comprises:
in case that the transmission period of the first UWB advertisement message is greater than a sampling rate, determining the second scheme for identifying the user gesture input of the first UWB device.

18. The method of claim 16, further comprising:
in case that the second scheme is determined for identifying the user gesture input, identifying the user gesture input, based on first AoA information for a plurality of received UWB advertisement messages, second AoA information for a plurality of UWB messages obtained through the TWR, and information about a distance to the third UWB device.

19. The method of claim 16, further comprising:
in case that the second scheme is determined for identifying the user gesture input, transmitting, to the third UWB device, a UWB TWR session start request.

20. The method of claim 16, wherein the first UWB advertisement message is broadcast periodically from the second UWB device, and
wherein the second UWB device is a fixed device.

21. The method of claim 16, wherein the first UWB advertisement message includes application data related to a service to be initiated by the first UWB advertisement message.

22. The method of claim 16, further comprising:
receiving, from the second UWB device, a second UWB advertisement message for the AoA measurement with the third UWB device; and
in case that a UWB TWR session is not terminated, determining the second scheme for identifying the user gesture input of the first UWB device.

23. The method of claim 16, wherein the first UWB advertisement message is transmitted within a single ranging round configured for the AoA measurement with the third UWB device within a ranging block.

24. A first ultra-wide band (UWB) device, comprising:
a transceiver; and
a controller,
wherein the controller is configured to:
receive, from a second UWB device, a first UWB advertisement message for measurement of an angle of arrival (AoA) with a third UWB device, wherein the first UWB advertisement message is for UWB one-way ranging (OWR) and includes information about a transmission period of the first UWB advertisement message, and
determine, based on the information about the transmission period, a scheme for identifying a user gesture input of the first UWB device, and
wherein the scheme for identifying the user gesture input includes a first scheme using the UWB OWR to identify the user gesture input or a second scheme using both the UWB OWR and UWB two-way ranging (TWR) with the third UWB device to identify the user gesture input.

25. The first UWB device of claim 24, wherein the controller is further configured to:
in case that the transmission period of the first UWB advertisement message is greater than a sampling rate, determine the second scheme for identifying the user gesture input of the first UWB device.

26. The first UWB device of claim 24, wherein the controller is further configured to:
in case that the second scheme is determined for identifying the user gesture input, identify the user gesture input based on first AoA information for a plurality of received UWB advertisement messages, second AoA information for a plurality of UWB messages obtained through the TWR, and information about a distance to the third UWB device.

27. The first UWB device of claim 24, wherein the controller is further configured to:
in case that the second scheme is determined for identifying the user gesture input, transmit, to the third UWB device, a UWB TWR session start request.

28. The first UWB device of claim 24, wherein the first UWB advertisement message is broadcast periodically from the second UWB device, and
wherein second UWB device is a fixed device.

29. The first UWB device of claim 24, wherein the first UWB advertisement message includes application data related to a service to be initiated by the first UWB advertisement message.

30. The first UWB device of claim 24, wherein the first UWB advertisement message is transmitted within a single ranging round configured for the AoA measurement with the third UWB device within a ranging block.

31. The first UWB device of claim 24, wherein the controller is further configured to:
receive, from the second device, a second UWB advertisement message for the AoA measurement with the third UWB device, and
in case that a UWB TWR session is not terminated, determine the second scheme for identifying the user gesture input of the first UWB device.
